(19) United States
(12) Patent Application Publication
(10) Pub. No.: US 2025/0035967 A1
(43) Pub. Date: Jan. 30, 2025

(54) OPTICAL MODULATOR, OPTICAL TRANSMITTER-RECEIVER, AND OPTICAL TRANSCEIVER

(71) Applicant: FUJITSU OPTICAL COMPONENTS LIMITED, Kawasaki-shi (JP)

(72) Inventors: Kazumasa SATO, Chigasaki (JP); Nobuaki MITAMURA, Saitama (JP)

(73) Assignee: FUJITSU OPTICAL COMPONENTS LIMITED, Kawasaki-shi (JP)

(21) Appl. No.: 18/753,015

(22) Filed: Jun. 25, 2024

(30) Foreign Application Priority Data
Jul. 28, 2023 (JP) 2023-123655

(51) Int. Cl. G02F 1/03; G02F 1/035; H04B 10/40

(52) U.S. Cl. CPC G02F 1/0316; G02F 1/035; H04B 10/40

(57) ABSTRACT

An optical modulator includes an electro-optic layer including an electro-optic material, and a material layer arranged below the electro-optic layer and having a dielectric constant lower than a dielectric constant of the electro-optic layer. The optical modulator includes a core layer arranged below the material layer and having a refractive index higher than refractive indices of the electro-optic layer and the material layer, and an electrode that applies an electric signal to the electro-optic layer. The refractive index of the material layer is 0.85 times the refractive index of the electro-optic layer or higher.

### CROSS-REFERENCE TO RELATED APPLICATION

This application is based upon and claims the benefit of priority of the prior Japanese Patent Application No. 2023-123655, filed on Jul. 28, 2023, the entire contents of which are incorporated herein by reference.

### FIELD

The embodiments discussed herein are related to an optical modulator, an optical transmitter-receiver, and an optical transceiver.

### BACKGROUND

Higher communication speed and lower power consumption have been demanded for optical transmitter-receivers with the recent increase in the capacity of optical communication systems. In particular, highly efficient optical modulators are in great demand for optical transmitters. For example, a Mach-Zehnder (MZ) optical modulator using a ferroelectric electro-optic material having a high electro-optic coefficient, such as PbLaZrTiO₃ (PLZT) or BaTiO₃ (BTO), is one of means for implementing a small-sized and highly efficient optical modulator. For example, PLZT or BTO has an electro-optic coefficient of a few hundred pm/V and this electro-optic coefficient is significantly higher than 31 pm/V, the electro-optic coefficient of a LiNbO₃ (lithium niobate: LN) optical modulator. Therefore, the electro-optic coefficients of PLZT and BTO, for example, are suitable for materials for small-sized and highly efficient optical modulators.

FIG. 22 is a schematic plan view of an example of a conventional optical modulator 200. The optical modulator 200 illustrated in FIG. 22 has an input unit 201, a splitter 202, two modulation units 203 arranged in parallel with each other, a multiplexer 204, and an output unit 205. The optical modulator 200 is a Mach-Zehnder optical modulator that modulates the intensity and phase of an optical signal output from the output unit 205 by performing, according to an electric signal, optical phase modulation of signal light that is from the input unit 201, that has been optically split, and that pass through the modulation units 203. The splitter 202 is a coupler that optically splits signal light from the input unit 201 and outputs the signal light that has been optically split, to the modulation units 203.

The modulation units 203 have a modulation waveguide 211 and an electrode 212. The modulation waveguide 211 is, for example, a waveguide using an electro-optic (EO) material, such as PLZT or BTO. The modulation waveguide 211 has a first modulation waveguide 211A and a second modulation waveguide 211B. The electrode 212 has a signal electrode 212A, a first ground electrode 212B, and a second ground electrode 212C. A first modulation unit 203A has the first ground electrode 212B, the signal electrode 212A, and the first modulation waveguide 211A that is arranged between the first ground electrode 212B and the signal electrode 212A. A second modulation unit 203B has the second ground electrode 212C, the signal electrode 212A, and the second modulation waveguide 211B that is arranged between the second ground electrode 212C and the signal electrode 212A.

FIG. 23 is a schematic sectional view taken on a line C-C illustrated in FIG. 22. A portion at a cross section illustrated in FIG. 23 is a portion at a cross section of the first modulation unit 203A of the optical modulator 200. The first modulation unit 203A has a Si substrate not illustrated in the drawings, a lower cladding layer 221, an EO layer 222, an upper cladding layer 223, the signal electrode 212A, and the first ground electrode 212B. The lower cladding layer 221 is, for example, a buffer layer of SiO₂ arranged on the Si substrate. The EO layer 222 is, for example, a layer of a ferroelectric EO material, such as BTO or PLZT, having a high electro-optic coefficient. The EO layer 222 has been processed to have, for example, a rib-shaped sectional structure so that signal is guided therethrough and the EO layer 222 serves as a core layer of the first modulation waveguide 211A. The upper cladding layer 223 is, for example, a buffer layer of SiO₂ arranged on the EO layer 222 and covering an upper area of the EO layer 222, the upper area being around a core 211A1 of the first modulation waveguide 211A that is rib shaped. The core 211A1 of the first modulation waveguide 211A has been arranged in parallel with and between the first ground electrode 212B and the signal electrode 212A.

An electric field is generated from the signal electrode 212A to the first ground electrode 212B in the first modulation unit 203A according to a high frequency electric signal from the signal electrode 212A and a change is caused in the optical refractive index of the first modulation waveguide 211A according to the electric field. The first modulation unit 203A modulates the phase of signal light guided through the first modulation waveguide 211A according to the change in the optical refractive index. The first modulation unit 203A outputs the signal light that has been modulated, to the multiplexer 204.

An electric field from the signal electrode 212A to the second ground electrode 212C in the second modulation unit 203B is generated according to a high frequency electric signal from the signal electrode 212A and a change is caused in the optical refractive index of the second modulation waveguide 211B according to the electric field. The second modulation unit 203B modulates the phase of signal light guided through the second modulation waveguide 211B according to the change in the optical refractive index. The second modulation unit 203B outputs the signal light that has been modulated, to the multiplexer 204.

The multiplexer 204 multiplexes the modulated signal light from the first modulation unit 203A and the modulated signal light from the second modulation unit 203B together and outputs the multiplexed signal light to the output unit 205. Interference is generated in the multiplexer 204 according to states of the phases in the first modulation unit 203A and the second modulation unit 203B and as a result, signal light having its intensity and phase modulated is output from the output unit 205.
Patent Literature 1: Japanese Laid-open Patent Publication No. 63-049732
Patent Literature 2: Japanese Laid-open Patent Publication No. 2022-032687
Patent Literature 3: U.S. Pat. No. 7,283,689
Patent Literature 4: Japanese Laid-open Patent Publication No. 2007-333756

Dependence of propagation characteristics of an electric signal on the dielectric constant in the optical modulator 200 will be described next. FIG. 24 is a diagram illustrating an example of a relation between: the relative dielectric constant that is a physical property constant determined by the material of the EO layer 222; and the characteristic impedance. FIG. 25 is a diagram illustrating an example of a relation between the relative dielectric constant of the EO layer 222 and the electric signal loss. FIG. 26 is a diagram illustrating an example of a relation between the relative dielectric constant of the EO layer 222 and the electric signal refractive index. The ferroelectric EO material used in the EO layer 222 of the modulation waveguide 211 has a relative dielectric constant of several hundreds.

That is, the relative dielectric constant of the EO layer 222 of PLZT or BTO, for example, is significantly higher than the relative dielectric constant of LN used in a waveguide of a conventional optical modulator. As a result, as illustrated in FIG. 24, the characteristic impedance of the optical modulator 200 using the EO layer 222 of PLZT or BTO, for example, becomes lower than the characteristic impedance of an optical modulator using an EO layer of LN. Furthermore, the electric signal loss in the optical modulator 200 using the EO layer 222 of PLZT or BTO, for example, becomes higher than the electric signal loss in the optical modulator using the EO layer of LN, as illustrated in FIG. 25. In addition, the electric signal refractive index of the optical modulator 200 using the EO layer 222 of PLZT or BTO, for example, becomes higher than the electric signal refractive index of the optical modulator using the EO layer of LN, as illustrated in FIG. 26.

The higher electric signal refractive index of the optical modulator 200 using the EO layer 222 of PLZT or BTO, for example, leads to a velocity mismatch resulting from a difference between the propagation velocity of light and the propagation velocity of an electric signal.

Specifically, the group refractive index prescribing the propagation velocity of light guided through an optical waveguide using an EO material, such as BTO or PLZT, is, for example, in a range of 2 to 2.5. By contrast, the electric signal refractive index prescribing the propagation velocity of an electric signal applied to an optical waveguide using an EO material, such as BTO or PLZT, is 3 or higher because its relative dielectric constant is very high at several hundreds. A velocity mismatch is thus generated due to the large difference between the propagation velocity of light and the propagation velocity of an electric signal. As a result, the 3 dB band of the optical response of the optical modulator 200 will be significantly limited in the optical modulator 200, for example.

In a case where a velocity mismatch is generated, decreasing the waveguide length in the optical modulator 200 may minimize the influence of the velocity mismatch. However, in this case, because the operating length of the optical modulator 200 is decreased, the half wavelength voltage Vπ to change the phase of the optical modulator 200 by π increases and the modulation efficiency of the optical modulator 200 is decreased. That is, in a case where a velocity mismatch is generated, the effect of improving the modulation efficiency by use of a material having a high electro-optic coefficient will not be achieved.

Therefore, in a case where an EO material having a high dielectric constant, such as PLZT or BTO, is used for the core 211A1 of the optical modulator 200, successfully securing the 3 dB band well and achieving high modulation efficiency (a low Vπ) at the same time for the optical modulator 200 will be difficult.

### SUMMARY

According to an aspect of an embodiment, an optical modulator includes an electro-optic layer, a material layer, a core layer, and an electrode. The electro-optic layer includes an electro-optic material. The material layer is arranged below the electro-optic layer and has a dielectric constant lower than a dielectric constant of the electro-optic layer. The core layer is arranged below the material layer and has a refractive index higher than refractive indices of the electro-optic layer and the material layer. The electrode applies an electric signal to the electro-optic layer. The refractive index of the material layer is 0.85 times the refractive index of the electro-optic layer or higher.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan view of an example of an optical modulator according to a first embodiment;

FIG. 2 is a schematic sectional view taken on a line A-A illustrated in FIG. 1;

FIG. 3 is a diagram illustrating an example of a relation between the thickness of an EO layer of the optical modulator and the electric signal refractive index;

FIG. 4 is a diagram illustrating an example of a relation between the thickness of a Si core of the optical modulator and the optical group refractive index;

FIG. 5 is a diagram illustrating an example of a relation between the thickness of a material layer of the optical modulator and the half wavelength voltage Vπ;

FIG. 6 is a diagram illustrating an example of a relation between the thickness of the material layer of the optical modulator and the optical group refractive index;

FIG. 7A is a diagram illustrating an example of an SOI substrate used for a Si core substrate;

FIG. 7B is a diagram illustrating an example of a process of forming a Si thin film in the SOI substrate;

FIG. 7C is a diagram illustrating an example of a Si patterning process;

FIG. 7D is a diagram illustrating an example of a SiO₂ film formation process;

FIG. 7E is a diagram illustrating an example of the Si core substrate that has been subjected to surface planarization polishing;

FIG. 8A is a diagram illustrating an example of an EO substrate used for an EO thin film substrate;

FIG. 8B is a diagram illustrating an example of a first attachment process;

FIG. 8C is a diagram illustrating an example of a first removal process;

FIG. 8D is a diagram illustrating an example of the EO thin film substrate;

FIG. 9A is a diagram illustrating an example of a second attachment process;

FIG. 9B is a diagram illustrating an example of a second removal process;

FIG. 9C is a diagram illustrating an example of an upper cladding layer formation process;

FIG. 9D is a diagram illustrating an example of a metal layer film formation process;

FIG. 9E is a diagram illustrating an example of a metal patterning process;

FIG. 10 is a schematic sectional view of an example of an optical modulator according to a second embodiment;

FIG. 11 is a diagram illustrating an example of a relation between the relative dielectric constant of an upper cladding layer of the optical modulator and the electric signal loss;

FIG. 12 is a diagram illustrating an example of a relation between the relative dielectric constant of the upper cladding layer of the optical modulator and the electric signal refractive index;

FIG. 13 is a diagram illustrating an example of a relation between the refractive index of the upper cladding layer of the optical modulator and the half wavelength voltage Vπ;

FIG. 14 is a schematic sectional view of an example of an optical modulator according to a third embodiment;

FIG. 15 is a diagram illustrating an example of a relation between the refractive index of a first material layer of the optical modulator and the optical loss;

FIG. 16 is a diagram illustrating an example of a relation between the dielectric constant of the first material layer of the optical modulator and the half wavelength voltage Vπ;

FIG. 17 is a schematic plan view illustrating an example of an IQ optical modulator according to a fourth embodiment;

FIG. 18 is a schematic sectional view taken on a line B-B illustrated in FIG. 17;

FIG. 19 is a schematic plan view illustrating an example of a DP-IQ optical modulator according to a fifth embodiment;

FIG. 20 is a schematic plan view illustrating an example of an optical transmitter-receiver according to a sixth embodiment;

FIG. 21 is a diagram illustrating an example of an optical transceiver;

FIG. 22 is a schematic plan view of an example of a conventional optical modulator;

FIG. 23 is a schematic sectional view taken on a line C-C illustrated in FIG. 22;

FIG. 24 is a diagram illustrating an example of a relation between: the relative dielectric constant that is a physical property constant determined by a material for an EO layer; and the characteristic impedance;

FIG. 25 is a diagram illustrating an example of a relation between the relative dielectric constant of the EO layer and the electric signal loss; and

FIG. 26 is a diagram illustrating an example of a relation between the relative dielectric constant of the EO layer and the electric signal refractive index.

### DESCRIPTION OF EMBODIMENTS

Preferred Embodiments of the Present Invention will be explained with reference to accompanying drawings. The present invention is not to be limited by these embodiments.

### (a) First Embodiment

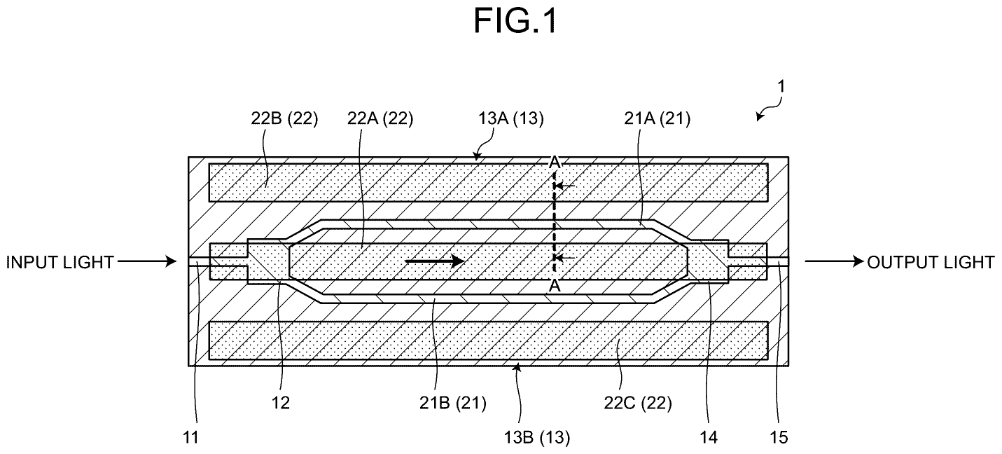

FIG. 1 is a schematic plan view illustrating an example of an optical modulator 1 according to a first embodiment. The optical modulator 1 has an input unit 11, a splitter 12, two modulation units 13, a multiplexer 14, and an output unit 15. The optical modulator 1 is a Mach-Zehnder optical modulator that optically modulates, according to an electric signal, signal light that is from the input unit 11 and that has been optically split. The input unit 11 is a part that is connected to an input waveguide and that inputs signal light from the input waveguide to the optical modulator 1. The output unit 15 is a part that is connected to an output waveguide and that outputs signal light that is from the optical modulator 1 and that has been modulated, to the output waveguide. The splitter 12 is, for example, a 1×2 MMI coupler that optically splits signal light from the input unit 11 and outputs the optically split signal light respectively to the modulation units 13. The multiplexer 14 is, for example, a 2×1 MMI coupler that multiplexes the modulated signal light from the modulation units 13 together and outputs the multiplexed signal light to the output unit 15.

The modulation units 13 have a first modulation unit 13A and a second modulation unit 13B. The modulation units 13 have modulation waveguides 21 and electrodes 22. The modulation waveguides 21 are, for example, waveguides each having a core made of Si. The modulation waveguides 21 have a first modulation waveguide 21A and a second modulation waveguide 21B. The electrodes 22 have a GSG configuration having a signal electrode 22A, a first ground electrode 22B, and a second ground electrode 22C.

The first modulation unit 13A has the first modulation waveguide 21A, the signal electrode 22A, and the first ground electrode 22B, and the first modulation waveguide 21A is arranged between the first ground electrode 22B and the signal electrode 22A. An electric field is generated from the signal electrode 22A to the first ground electrode 22B in the first modulation unit 13A according to a high frequency electric signal from the signal electrode 22A and the optical refractive index of the first modulation waveguide 21A is changed according to the electric field. The first modulation unit 13A performs phase modulation of signal light guided through the first modulation waveguide 21A, according to a change in the optical refractive index. The first modulation unit 13A outputs the signal light that has been modulated, to the multiplexer 14.

The second modulation unit 13B has the second modulation waveguide 21B, the signal electrode 22A, and the second ground electrode 22C, and the second modulation waveguide 21B is arranged between the second ground electrode 22C and the signal electrode 22A. An electric field is generated from the signal electrode 22A to the second ground electrode 22C in the second modulation unit 13B according to a high frequency electric signal from the signal electrode 22A and the optical refractive index of the second modulation waveguide 21B is changed according to the electric field. The second modulation unit 13B modulates signal light guided through the second modulation waveguide 21B, according to a change in the optical refractive index. The second modulation unit 13B outputs the signal light that has been modulated, to the multiplexer 14.

The multiplexer 14 multiplexes the modulated signal light from the first modulation unit 13A and the modulated signal light from the second modulation unit 13B together and outputs the multiplexed signal light to the output unit 15.

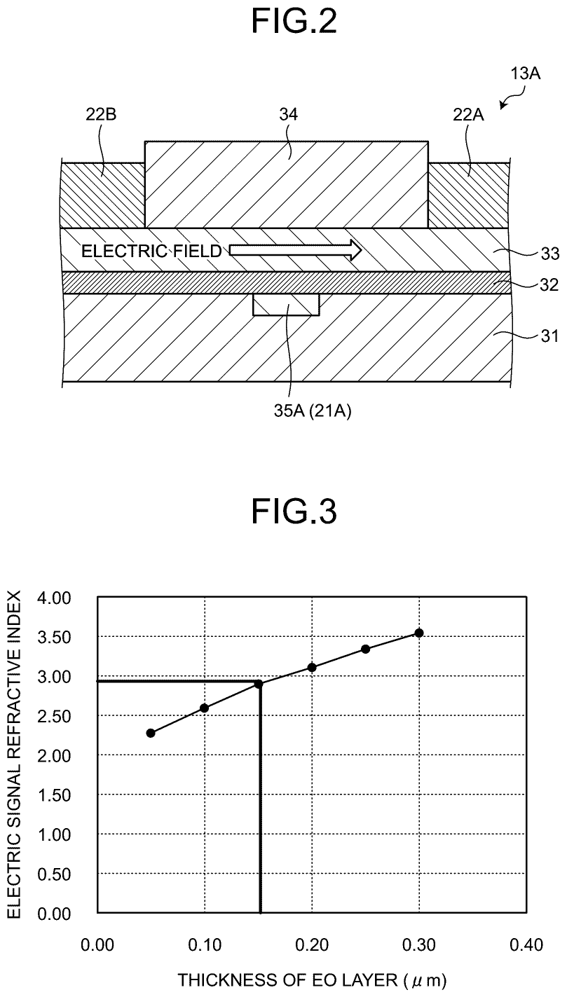

FIG. 2 is a schematic sectional view taken on a line A-A illustrated in FIG. 1. A portion at a cross section illustrated in FIG. 2 is a portion at a cross section of the first modulation unit 13A illustrated in FIG. 1. The first modulation unit 13A has a Si substrate not illustrated in the drawings, a lower cladding layer 31, a Si core 35, a material layer 32, an EO layer 33, an upper cladding layer 34, the first ground electrode 22B, and the signal electrode 22A. The lower cladding layer 31 is, for example, a cladding layer of SiO₂ layered on the Si substrate. The Si core 35 is a core layer of an optical waveguide formed in the lower cladding layer 31 and is, for example, a core of the first modulation waveguide 21A. The Si core 35 is arranged to be in contact with the downside of the material layer 32 below the EO layer 33.

The material layer 32 is a layer of, for example, Ta₂O₅ or amorphous Si, layered over surfaces of the lower cladding layer 31 and the Si core 35. The EO layer 33 is, for example, an electro-optic layer of an EO material, such as BTO, layered over a surface of the material layer 32. The upper cladding layer 34 is, for example, a cladding layer of SiO₂ arranged over an area around the Si core 35, the cladding layer covering a surface of the EO layer 33. The Si core 35 is interposed between the first ground electrode 22B and the signal electrode 22A that are arranged on the EO layer 33. The EO layer 33 and the material layer 32 have flat plate structures.

BTO serving as the EO material used in the EO layer 33 has, for example, an electro-optic coefficient of 100 to 400 pm/V, a relative dielectric constant of 150 or higher, and a refractive index of about 2.2, although these values depend on the method of formation thereof. Ta₂O₅ used in the material layer 32 has a relative dielectric constant of 28 and a refractive index of about 2.05. The EO layer 33 used in the optical modulator 1 has a thickness of 0.15 μm, the material layer 32 has a thickness of 0.02 μm, the Si core 35 has a width of 0.8 μm, and an interval between the electrodes 22 having the Si core 35 interposed therebetween is 4 μm. The material layer 32 is formed of a material having a dielectric constant lower than that of the EO layer 33. The Si core 35 is formed of silicon having a refractive index higher than the refractive indices of the EO layer 33 and the material layer 32. The refractive index of the material layer 32 is 0.85 times the refractive index of the EO layer 33 or higher.

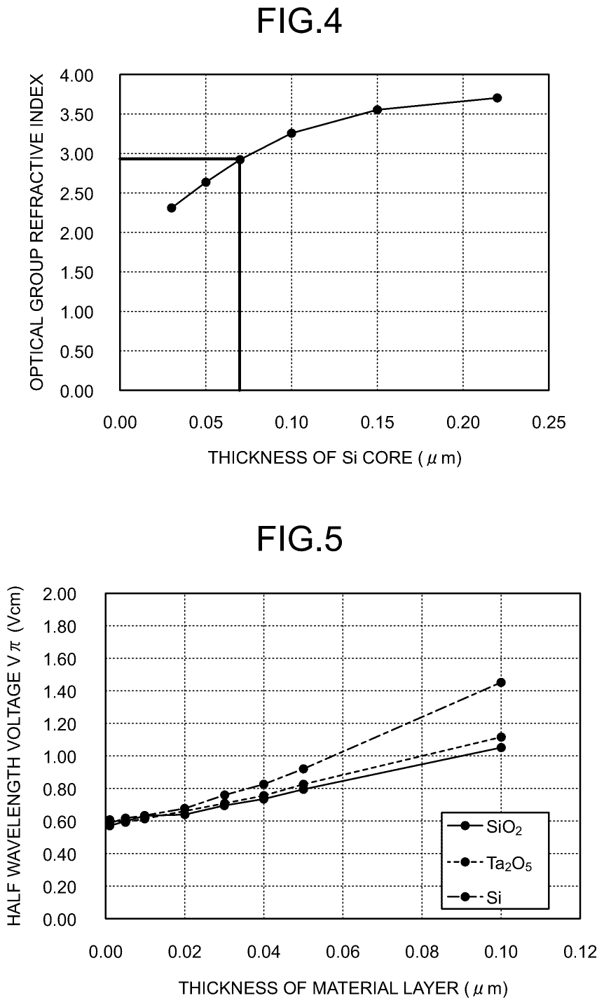

FIG. 3 is a diagram illustrating an example of a relation between the thickness of the EO layer 33 of the optical modulator 1 and the electric signal refractive index and FIG. 4 is a diagram illustrating an example of a relation between the thickness of the Si core 35 of the optical modulator 1 and the optical group refractive index. As illustrated in FIG. 3, when the thickness of the EO layer 33 becomes, for example, equal to or less than 0.15 μm in the optical modulator 1, the refractive index for a high frequency electric signal becomes comparative low at about 3.00 or lower. As illustrated in FIG. 4, when the thickness of the Si core 35 becomes, for example, equal to or larger than 0.07 μm in the optical modulator 1, the group refractive index for light propagating through the SI core 35 in the optical modulator 1 also becomes high at about 3.00 or higher. As a result, the conventional problem of the higher refractive index for an electric signal is solved, the propagation velocity of a high frequency electric signal and the propagation velocity of light in the optical modulator 1 become substantially the same, and the velocity mismatch is thus able to be improved. As a result of the improved velocity mismatch, the 3 dB band enabling the quantity of attenuation of the optical response level of the optical modulator 1 to be reduced to 3 dB or less is able to be implemented even in an operating band of 65 GHz or higher.

What is more, because the velocity mismatch is able to be improved, the length of the optical modulator 1 is able to be increased to about 4 mm. Therefore, the optical modulator 1 is able to have a sufficient operating length. The half wavelength voltage per unit length of the optical modulator 1 having the above described sectional structure becomes high at about 0.6 Vcm. A combination of this higher modulation efficiency and the increased length of the optical modulator 1 resulting from the improvement of the velocity mismatch enables the optical modulator 1 to have a half wavelength voltage Vπ of 2.0 V or lower and thus to be highly efficient.

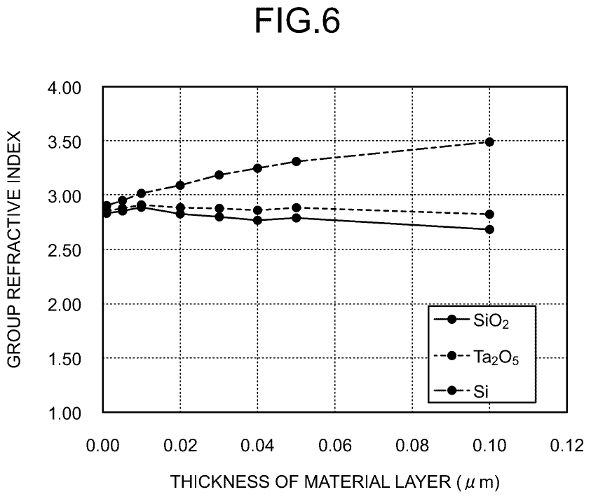

FIG. 5 is a diagram illustrating an example of a relation between the thickness of the material layer 32 of the optical modulator 1 and the half wavelength voltage Vπ and FIG. 6 is a diagram illustrating an example of relation between the thickness of the material layer 32 of the optical modulator 1 and the optical group refractive index. For convenience of description, SiO₂, Ta₂O₅, and Si will be described as examples of the material for the material layer 32. It is assumed herein that SiO₂ has a refractive index of 1.444, Ta₂O₅ has a refractive index of 2.05, and Si has a refractive index of 3.45.

The half wavelength voltage Vπ of the optical modulator 1 tends to increase as the thickness of the material layer 32 increases, as illustrated in FIG. 5. For all of these materials, up to a thickness of the material layer 32 of about 0.02 μm, the increase in the half wavelength voltage Vπ is at a negligible level and up to a thickness of the material layer 32 of about 0.05 μm, the half wavelength voltage Vπ is able to be maintained low at 1 Vcm or lower. Therefore, the thickness of the material layer 32 is at least desirably set to 0.05 μm or smaller.

As illustrated in FIG. 6, using SiO₂ as the material for the material layer 32 is contrary to the object of increasing the group refractive index for light in terms of improving the velocity mispatch because the group refractive index for light tends to decrease as the thickness of the material layer 32 increases. Using a material having a low refractive index for the material layer 32 is not preferable, and a material, such as Ta₂O₅, having a refractive index close to the refractive index (2.2) of the EO layer 33, or a material, such as Si including amorphous Si, for example, having a refractive index higher than that of the EO layer 33 is preferable.

In particular, using Si as the material for the material layer 32 is preferable in terms of improving the velocity mismatch because the optical group refractive index is able to be increased as the thickness of the material layer 32 is increased. Therefore, the refractive index of the material layer 32 is preferably about the same as the refractive index of the EO layer 33 or higher and a material having a refractive index higher than at least 0.85 times the refractive index of the EO layer 33 is preferably used at least for the material layer 32.

Preferably, the material layer 32 is formed of a material different from that for the EO layer 33, has an electro-optic coefficient and a relative dielectric constant lower than those of the EO layer 33, and the material has a low absorption coefficient for signal light.

The material used for the material layer 32 also preferably serves as an adhesive layer that improves adhesiveness between the Si core 35 and the EO layer 33, and for example, Ta₂O₅ or Si is a suitable material in terms of the refractive index and the role as the adhesive layer.

The material used for the EO layer 33 of the optical modulator 1 is preferably an electro-optic material having an electro-optic coefficient of about 50 pm/V or higher and a relative dielectric constant of about 50 or higher, and the material used for the material layer 32 is preferably a material having an electro-optic coefficient and a relative dielectric constant lower than those of the EO layer 33 and a low absorption coefficient for signal light. Furthermore, the material for the material layer 32 is preferably a material having a refractive index that is 0.85 times the refractive index of the EO layer 33 or higher. The Si core 35 has been described as an example of the core layer of the optical modulator 1 but the core layer may be any core layer having a refractive index higher than the refractive indices of the EO layer 33 and the material layer 32.

A process of manufacturing the optical modulator 1 according to the first embodiment will be described next. The optical modulator 1 has, for example, a Si core substrate 40A having a pattern of the Si core 35, the pattern having been formed on a surface of the Si core substrate 40A, and an EO thin film substrate 45A having a thin film of the EO layer 33 of BTO or PLZT, for example, the thin film having been formed on a Si substrate with a SiO₂ film interposed between the thin film and the Si substrate. The optical modulator 1 is formed by attaching the Si core substrate 40A and the EO thin film substrate 45A to each other and forming the electrodes 22 on the EO layer 33.

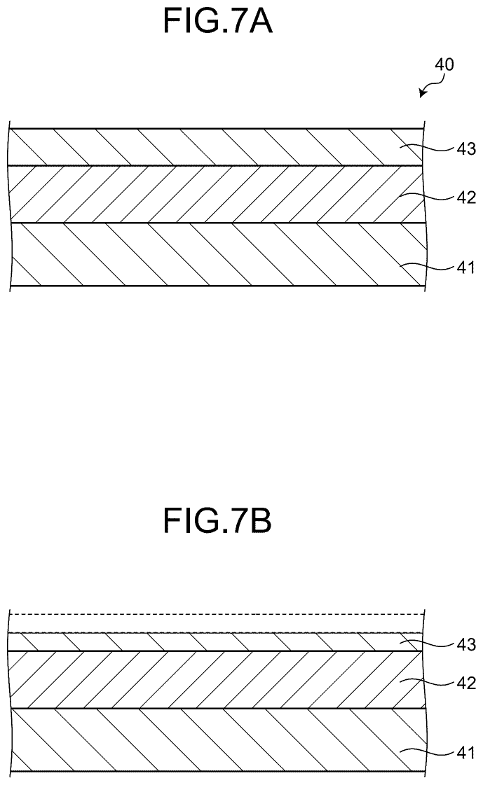

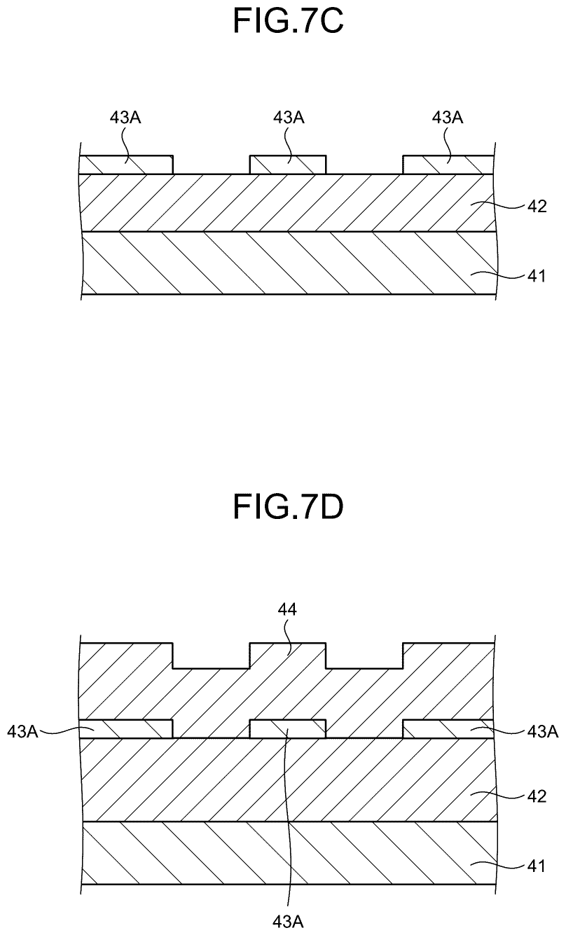

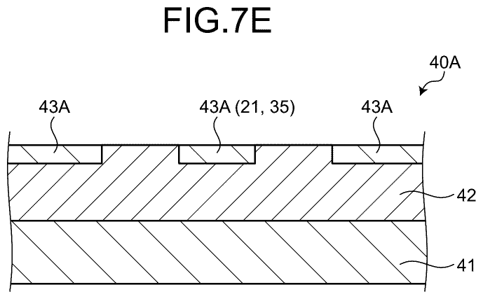

A process of manufacturing the Si core substrate 40A will be described first. FIG. 7A is a diagram illustrating an example of an SOI substrate 40 used for the Si core substrate 40A. The SOI substrate 40 has a Si substrate 41, a BOX layer 42 layered on the Si substrate 41, and a Si layer 43 layered on the BOX layer 42. The Si layer 43 is a Si layer that is used in silicon photonics and has a thickness of 0.22 μm.

FIG. 7B is a diagram illustrating an example of a process of forming a Si thin film in the SOI substrate 40. The Si layer 43 in the SOI substrate 40 is made into a thin film having a thickness of about 0.07 μm by, for example, etching, as illustrated in FIG. 7B.

FIG. 7C is a diagram illustrating an example of a Si patterning process. The Si layer 43 that has been made into the Si thin film is formed into a Si layer 43A by patterning, as illustrated in FIG. 7C. FIG. 7D is a diagram illustrating an example of a SiO₂ film formation process. As illustrated in FIG. 7D, after the patterning, a SiO₂ film 44 is formed on the Si layer 43A and the BOX layer 42.

FIG. 7E is a diagram illustrating an example of the Si core substrate 40A that has been subjected to surface planarization polishing. A surface of the SiO₂ film 44 is polished to a level near a surface of the Si layer 43A in the SOI substrate 40, the Si layer 43A is thereby exposed on the surface, and the Si core substrate 40A is thereby formed.

In a structure of the Si core substrate 40A illustrated herein as an example, the surface of the Si core substrate 40A has ideally been planarized and the surface of the Si layer 43A and the surface of the SiO₂ film 44 on both sides of the Si layer 43A are on the same plane. However, in consideration of a difference between amounts of the materials removed in the planarization, the Si core substrate 40A may be structured so that the surface of the SiO₂ film 44 is at a height lower than that of the surface of the Si layer 43A. Even in this case, substantially the same half wavelength voltage Vπ and optical group refractive index are able to be obtained. A substrate having high resistivity of 1000 Ωcm or higher is preferably used as the Si substrate 41 of the SOI substrate 40 in terms of improving the high frequency characteristics.

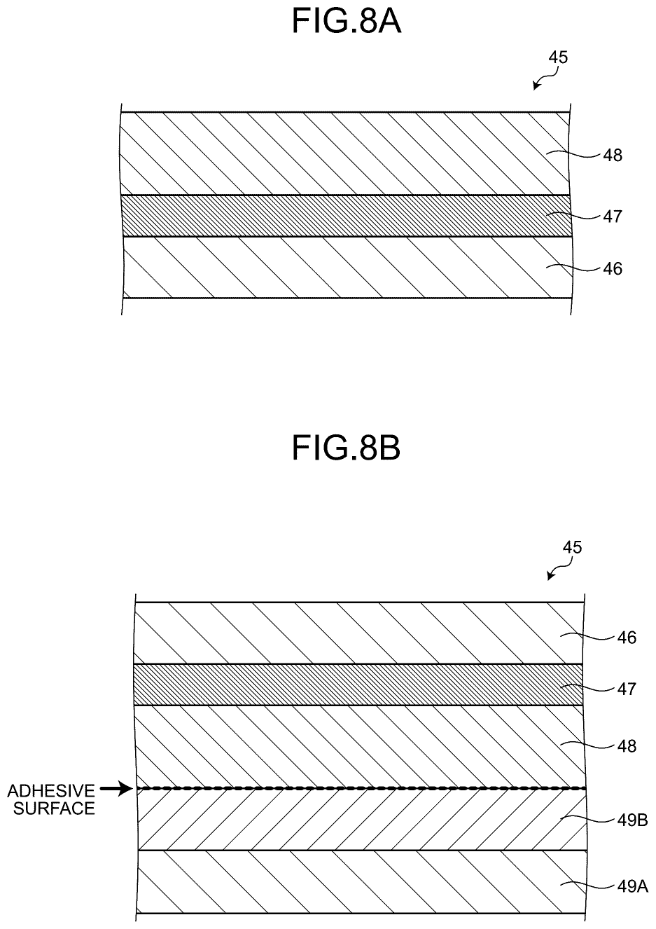

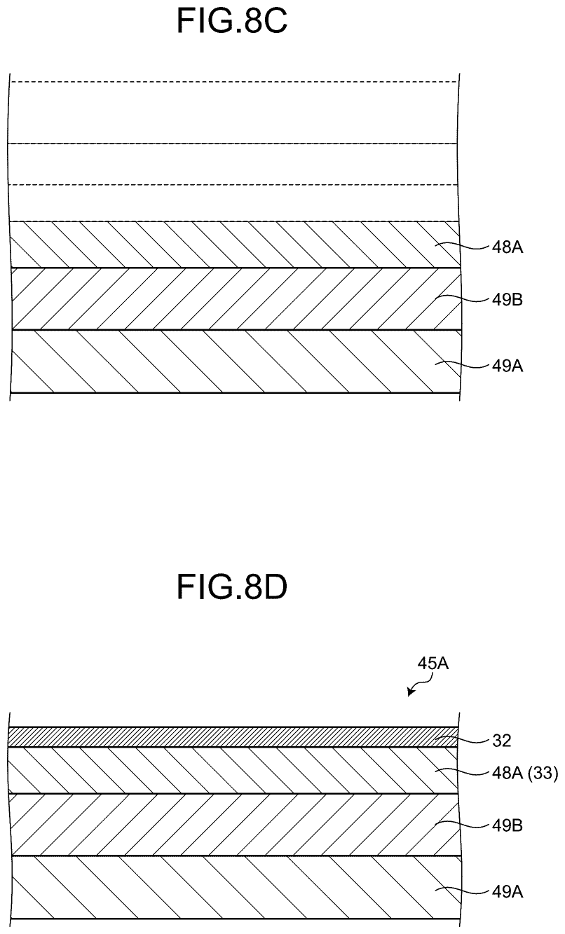

A process of manufacturing the EO thin film substrate 45A used for the optical modulator 1 will be described next. FIG. 8A is a diagram illustrating an example of an EO substrate 45 used for the EO thin film substrate 45A. The EO substrate 45 illustrated in FIG. 8A has a Si substrate 46, an intermediate layer 47 layered on the Si substrate 46, and an EO layer 48 layered on an intermediate layer 47. The EO layer 48 is formed of a ferroelectric EO material, such as BTO. The intermediate layer 47 is, for example, a layer of any one of ZrO₂, Pt, and SrRuO₃ (SRO). Forming the EO layer 48 directly on the Si substrate 46 deteriorates the quality of the crystal in the ferroelectric EO material and the EO layer 48 is thus formed on the Si substrate 46 via the intermediate layer 47.

FIG. 8B is a diagram illustrating an example of a first attachment process. A support substrate 49A where an upper cladding layer 49B is to be layered is prepared. The EO substrate 45 is flipped vertically, and as illustrated in FIG. 8B, the upper cladding layer 49B and the EO layer 48 in the EO substrate 45 are attached to each other with an adhesive. This attachment may be modified as appropriate and bonded surfaces between the EO layer 48 and the upper cladding layer 49B may be bonded to each other with a new adhesive layer.

The bonded surfaces between the upper cladding layer 49B and the EO layer 48 in the EO substrate 45 are desirably planarized by, for example, lapping polishing or chemical mechanical polishing (CMP). Surface washing and surface activation are preferably executed before the bonding. The upper cladding layer 49B and the EO layer 48 are attached to each other after the surface activation, but bonding may be executed under a vacuum atmosphere as needed or pressure may be applied at an appropriate temperature at the time of bonding.

FIG. 8C is a diagram illustrating an example of a first removal process. Subsequently, removing the Si substrate 46, the intermediate layer 47, and part of the EO layer 48 that are in the EO substrate 45 attached to the upper cladding layer 49B results in formation of an EO layer 48A having a predetermined thickness of, for example, 0.15 μm, as illustrated in FIG. 8C. Lapping polishing or chemical mechanical polishing (CMP) is desirably used as a method of removing them, for example.

FIG. 8D is a diagram illustrating an example of the EO thin film substrate 45A. As illustrated in FIG. 8D, the EO thin film substrate 45A is completed by formation of the material layer 32 on the EO layer 48A. As described already, the material for the material layer 32 is preferably a material having a refractive index that is about the same as that of the EO layer 48 or higher, and preferable examples of the material include tantalum oxide and a Si film. The material layer 32 provides adhesiveness between the Si core substrate 40A and the EO thin film substrate 45A. As described later, a modulation waveguide is formed by further attaching the EO layer 48A and the material layer 32 that is for improvement of adhesiveness, which are illustrated in FIG. 8D, to another substrate (FIG. 7D) where a Si core waveguide is formed. In such a method of attachment, a quality EO crystal film formed on a substrate where crystal grows easily is able to be separately attached onto a different substrate, and a structure having a combination of any substrate material and an EO material is thus able to be made comparatively easily as compared to direct film formation by epitaxial growth.

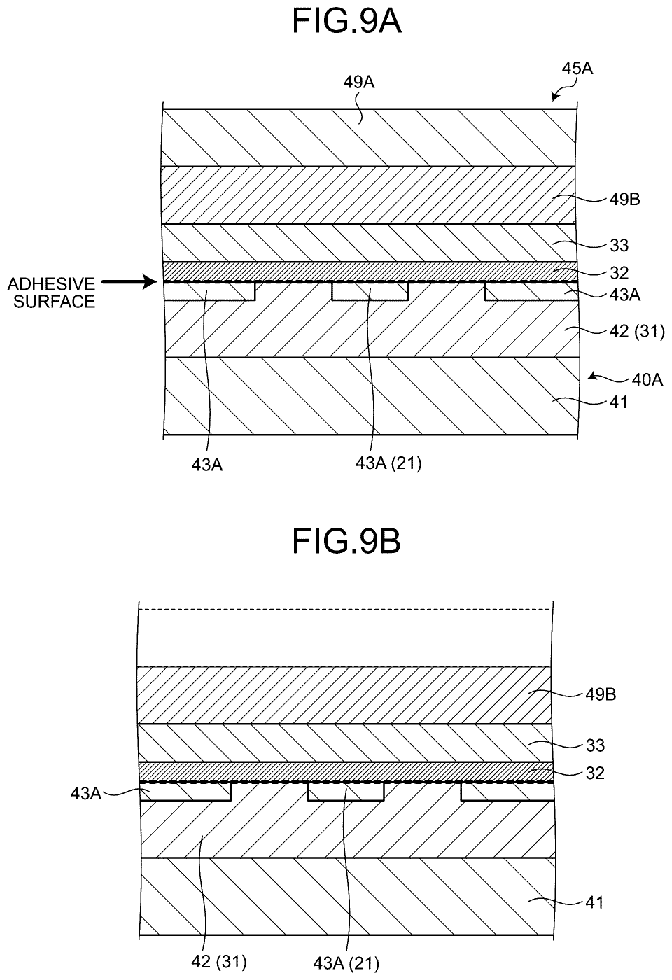

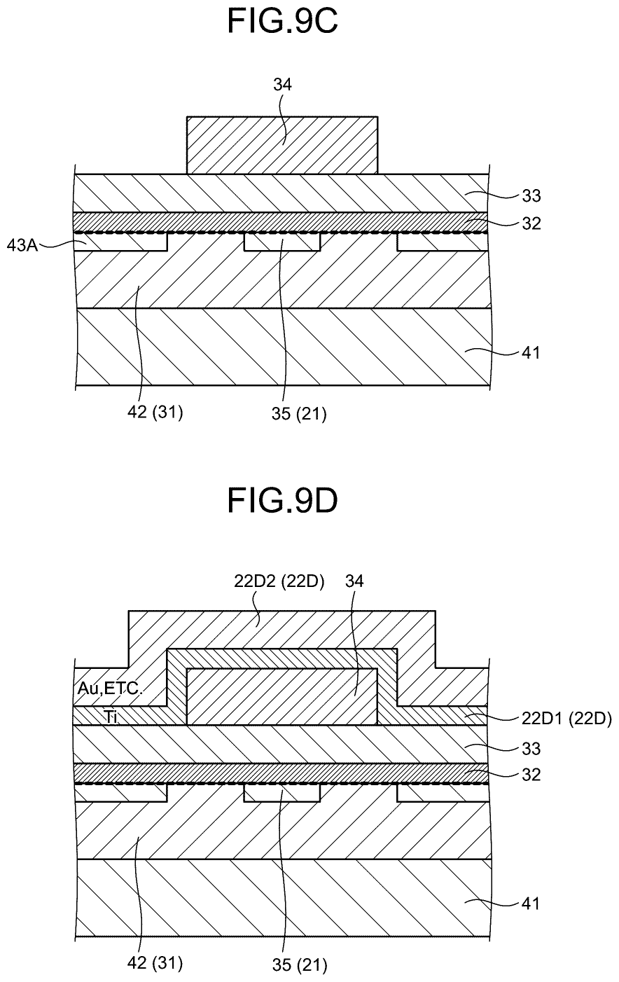

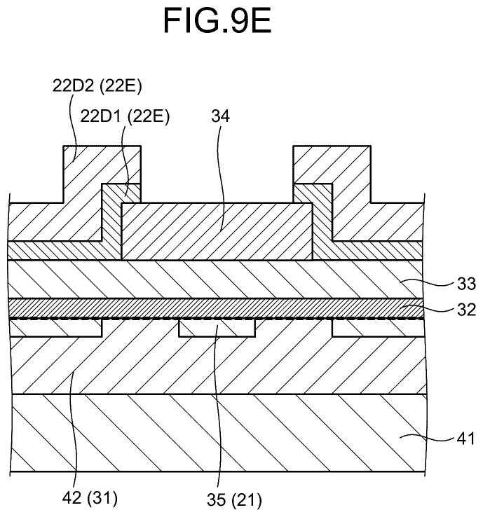

A method of manufacturing the optical modulator 1 by bonding between the Si core substrate 40A and the EO thin film substrate 45A will be described next. FIG. 9A is a diagram illustrating an example of a second attachment process. As illustrated in FIG. 9A, the EO thin film substrate 45A is reversed and the material layer 32 of the EO thin film substrate 45A that has been reversed and the Si layer 43A of the Si core substrate 40A are attached to each other. For convenience of description, if the size of the EO thin film substrate 45A is the same as the size of the Si core substrate 40A, the wafers may be stuck to each other as is. However, this attachment may be modified as appropriate, and if their sizes are different from each other, for example, the EO thin film substrate 45A may be diced into pieces each having a predetermined size and the plural pieces of the EO thin film substrate 45A may be attached onto the Si core substrate 40A by die bonding.

In a process of bonding the wafer of the EO thin film substrate 45A and the wafer of the Si core substrate 40A together, an exposed surface of the Si core substrate 40A is attached to a surface of the material layer 32 of the EO thin film substrate 45A, the exposed surface being where the Si core 35 is exposed. Before the attachment, the surface of the Si core substrate 40A and the surface of the EO thin film substrate 45A may be subjected to, for example, planarization, surface washing, and/or surface activation. Furthermore, the bonding may be modified as appropriate and may be performed under vacuum or at an appropriate temperature and an appropriate pressure as needed.

FIG. 9B is a diagram illustrating an example of a second removal process. After the Si core substrate 40A and the EO thin film substrate 45A have been attached to each other, as illustrated in FIG. 9B, the support substrate 49A on one side of the EO thin film substrate 45A is removed, the one side being opposite to a side where the EO layer 33 is. A process of selectively removing only Si from other materials by etching using XeF₂ gas is preferably used, for example, for the removal of the support substrate 49A.

FIG. 9C is a diagram illustrating an example of an upper cladding layer formation process. The upper cladding layer 34 is formed on the EO layer 33 by etching part of the upper cladding layer 49B illustrated in FIG. 9B. Part of the upper cladding layer 49B is able to be removed so that the electrodes 22 are able to be arranged on the EO layer 33. The etching is performed by, for example, reactive ion etching (RIE) or ion milling.

FIG. 9D is a diagram illustrating an example of a metal layer film formation process. After part of the upper cladding layer 34 has been removed, as illustrated in FIG. 9D, metal layers 22D used as the electrodes 22 are formed on surfaces of the EO layer 33 and the upper cladding layer 34, as illustrated in FIG. 9D. The metal layers 22D have, for example, a Ti film 22D1 serving as contact metal in contact with the EO layer 33, and an Au film 22D2 formed on the Ti film 22D1. The Ti film 22D1 and the Au film 22D2 may be formed by a method, such as vapor deposition, and in a case where the Au film 22D2 is to be made into a thick film, an additional plating process may be performed. The Au film 22D2 may be modified as appropriate and may be a film of, for example, Al, Ag, or Cu instead.

FIG. 9E is a diagram illustrating an example of a metal patterning process. Electrode patterns 22E are formed to have the Si core 35 interposed therebetween, as illustrated in FIG. 9E, so that an electric field is able to be applied to an area near the Si core 35, by removal of part of the metal layers 22D, the area being that of the upper cladding layer 34 having the metal layers 22D formed thereon as illustrated in FIG. 9D. As a result, the optical modulator 1 as illustrated in FIG. 1 is completed.

The optical modulator 1 according to the first embodiment has: the EO layer 33 including an electro-optic material; and the material layer 32 arranged below the EO layer 33 and having a dielectric constant lower than that of the EO layer 33. Furthermore, the optical modulator 1 has, for example: the Si core 35 arranged below the material layer 32 and having a refractive index higher than the refractive indices of the EO layer 33 and the material layer 32, for example, a refractive index of 3.45; and the electrodes 22 for application of an electric signal to the EO layer 33. The refractive index of the material layer 32 is 0.85 times the refractive index of the EO layer 33 or higher. That is, the refractive index for a high frequency electric signal and the group refractive index for light are made closer to each other by increase in the group refractive index through application of the Si core 35 having a high refractive index, the increase being in relation to the electric signal refractive index that tends to be comparatively high due to influence of the EO layer 33 having a high dielectric constant. As a result, the propagation velocity for a high frequency electric signal and the propagation velocity for light become substantially the same in the optical modulator 1, and the velocity mismatch between the propagation velocity of an electric signal and the propagation velocity of light is thus able to be improved. Therefore, the operating band of the optical modulator 1 is able to be prevented from being limited. What is more, because the velocity mismatch in the optical modulator 1 is improved, the operating length is able to be increased, the half wavelength voltage Vπ is able to be reduced, and the modulation efficiency of the optical modulator 1 is thus able to be improved.

Use of the Si core 35 made of a material having a high refractive index of 3.45 in the optical modulator 1 enables increase in the group refractive index for light propagated through the Si core 35. Furthermore, using the EO layer 33 having a high dielectric constant increases the refractive index for a high frequency electric signal, but increasing the group refractive index for light makes the group refractive index for light closer to the refractive index for a high frequency electric signal and alleviates the velocity mismatch. As a result, the operating length of the optical modulator 1 does not need to be decreased and is able to be increased, and the operating band of the optical modulator 1 is able to be secured with the modulation efficiency improved.

Because the material layer 32 is arranged between the EO layer 33 and the Si core 35 in the optical modulator 1, the adhesiveness between the Si core 35 and the EO layer 33 is able to be obtained. Because the EO layer 33 is a crystalline material, the EO layer 33 is formed by epitaxial growth, and forming the EO layer 33 on the Si core 35 and the lower cladding layer 31 is thus difficult. Therefore, the material layer 32 is arranged between: the Si core 35 and lower cladding layer 31; and the EO layer 33. In addition, because the refractive index of the material layer 32 is set to 0.85 times the refractive index of the EO layer 33 or higher, the group refractive index for light is able to be maintained or increased as compared to a case without the material layer 32. As a result, a stable structure of the optical modulator 1 is able to be achieved by increase in the adhesiveness between the Si core 35 and the EO layer 33 without the effect being deteriorated, the effect being the effect of improving the velocity match between the propagation velocity of a high frequency electric signal and the propagation velocity of light in the optical modulator 1.

The material for the EO layer 33 has an electro-optic coefficient higher than the electro-optic coefficient of the material for the material layer 32. As a result, a low half wavelength voltage Vπ is able to be achieved.

The EO layer 33 having a high electro-optic coefficient has a relative dielectric constant higher than 50, the electro-optic coefficient of the EO layer 33 is higher than 50 pm/V, and the material layer 32 has a relative dielectric constant of 50 or lower and an electro-optic coefficient of 50 pm/V or lower. As a result, the refractive index of the EO layer 33 for a high frequency electric signal is able to be made comparatively low and the group refractive index for light is able to be increased by means of the Si core 35.

The EO layer 33 includes a material including at least any one of BaTio₃ (BTO), PbLaZrTiO₃ (PLZT), and PbZrTiO₃ (PZT). The material layer 32 includes a material including at least any one of Ta₂O₅ and Si. The high electro-optic coefficients of these materials enable the half wavelength voltage Vπ to be reduced.

The EO layer 33 has a thickness in a range of 0.1 to 0.3 μm, the Si core 35 has a thickness in a range of 0.05 to 0.10 μm, and the material layer 32 has a thickness of 0.005 to 0.05 μm or smaller. As a result, the refractive index of a high frequency electric signal is able to be made comparatively low and the group refractive index for light is able to be increased by means of the Si core 35.

For convenience of description, a case where the EO layer 33, the material layer 32, and the upper cladding layer 34 in the optical modulator 1 are each formed of a single material has been described as an example. However, this example may be modified as appropriate, and for example, a combination of plural materials may be used for each of these layers, the materials having dielectric constants, refractive indices, and high electro-optic coefficients in ranges respectively considered to be preferable for the layers.

A joint portion where the input waveguide connected to the input unit 11 of the optical modulator 1 is connected to the Si core 35, or a joint portion where the output waveguide connected to the output unit 15 of the optical modulator 1 is connected to the Si core 35 may include a core thickness conversion portion. The core thickness conversion portion is a structure for conversion of thickness from the thickness of the Si core 35 of 0.05 to 0.10 μm, to a thickness of 0.15 μm or larger, for example. The core thickness conversion portion has a tapered structure that gradually changes in core width from the input waveguide to the Si core 35, or a tapered structure that gradually changes in core width from the Si core 35 to the output waveguide. As a result, coupling losses at the joint portions are able to be reduced.

A channel waveguide has been described as an example for the Si core 35 but this may be modified as appropriate and a ridge waveguide may be adopted instead, for example.

### (b) Second Embodiment

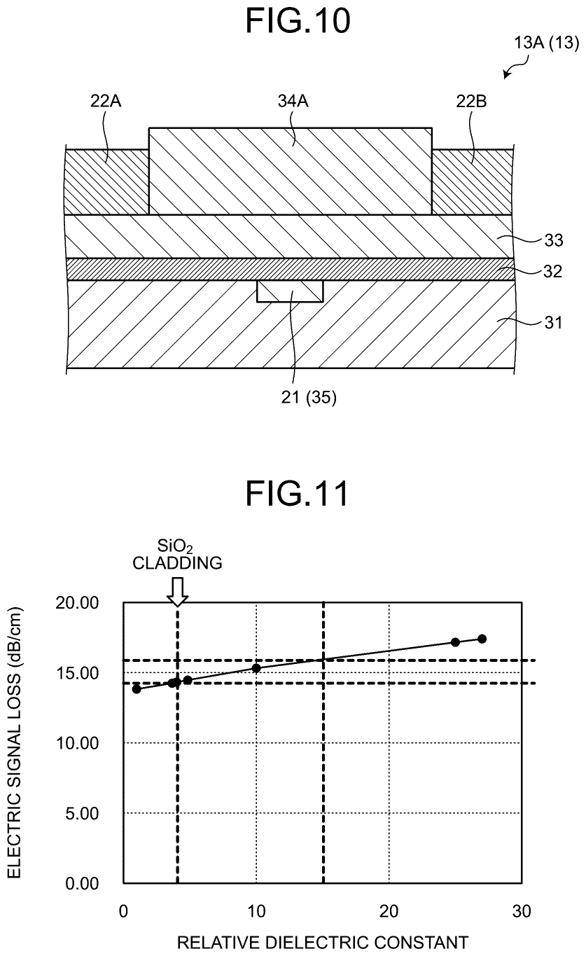

FIG. 10 is a schematic sectional view of an optical modulator 1 according to a second embodiment. By assignment of the same reference signs to components that are the same as those of the optical modulator 1 according to the first embodiment, description of the same components and operation thereof will be omitted. A portion at a cross section illustrated in FIG. 10 is a portion at a cross section of a first modulation unit 13A in the optical modulator 1. The optical modulator 1 according to the second embodiment is different from the optical modulator 1 according to the first embodiment in that an upper cladding layer 34A and a lower cladding layer 31 in the optical modulator 1 according to the second embodiment are made of materials different from each other.

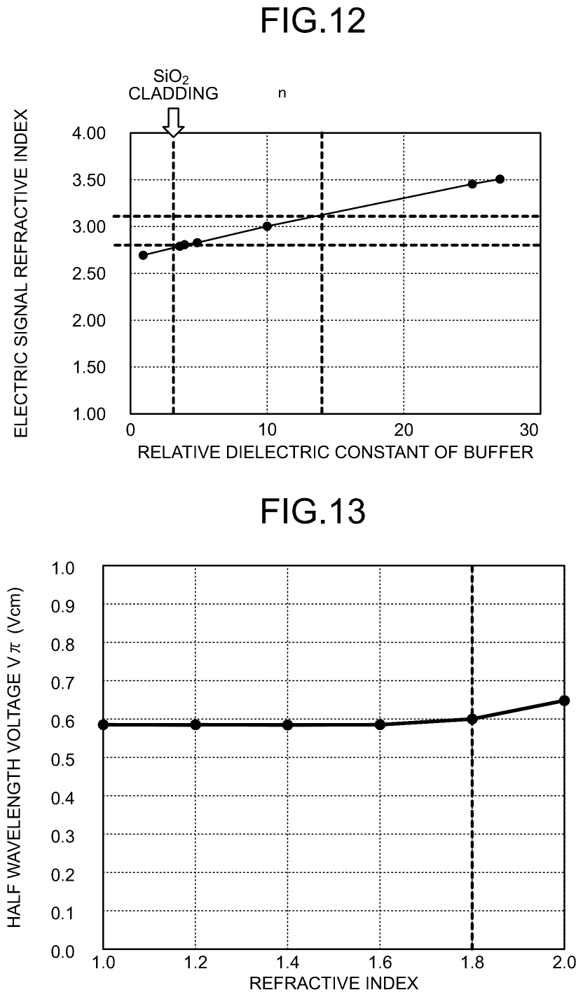

FIG. 11 is a diagram illustrating an example of a relation between the relative dielectric constant and the electric signal loss for the upper cladding layer 34A in the optical modulator 1, and FIG. 12 is a diagram illustrating an example of a relation between the relative dielectric constant and the electric signal refractive index for the upper cladding layer 34A in the optical modulator 1. Increasing the relative dielectric constant of the material for the upper cladding layer 34A, similarly to increasing the relative dielectric constant of an EO layer 33, as illustrated in FIG. 11, increases the electric signal loss (high frequency loss). Furthermore, increasing the relative dielectric constant of the material for the upper cladding layer 34A increases the electric signal refractive index (high frequency refractive index), as illustrated in FIG. 12. A material having a relative dielectric constant of 15 or lower is thus preferably adopted as the material for the upper cladding layer 34A to maintain each of the electric signal loss and the electric signal refractive index to 10% or less of that in a case where SiO₂ is adopted as the material.

FIG. 13 is a diagram illustrating an example of a relation between the refractive index and the half wavelength voltage Vπ of the upper cladding layer 34A in the optical modulator 1. When the refractive index of the upper cladding layer 34A is too high, the optical distribution is spread too much from the EO layer 33 to the upper cladding layer 34A and the optical modulation efficiency in the EO layer 33 is thereby decreased (the half wavelength voltage Vπ is increased), as illustrated in FIG. 13. A material having a refractive index of 1.8 or lower is thus preferably adopted as the material for the upper cladding layer 34A. Therefore, the material for the upper cladding layer 34A is preferably, for example, MgF₂, MgO, Al₂O₃, Y₂O₃, or a resin having a refractive index of 1.8 or lower, the material being other than SiO₂.

The material for the upper cladding layer 34A arranged on the EO layer 33 in the optical modulator 1 according to the second embodiment has a relative dielectric constant of 15 or lower and a refractive index of 1.8 or lower. As a result, the half wavelength voltage is able to be reduced and the modulation efficiency of the optical modulator 1 is able to be improved, with the electric signal loss and the electric signal refractive index being reduced.

### (c) Third Embodiment

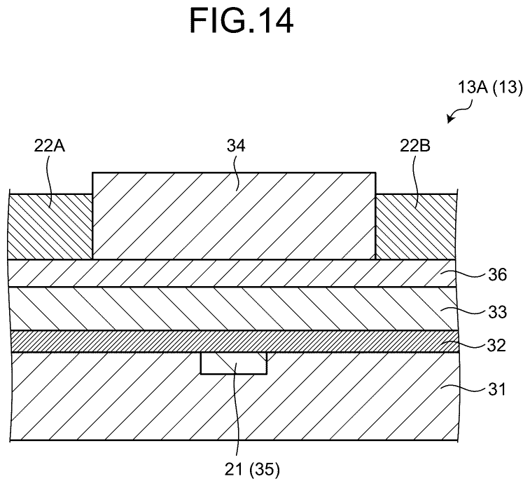

FIG. 14 is a schematic sectional view of an example of an optical modulator 1 according to a third embodiment. By assignment of the same reference signs to components that are the same as those of the optical modulator 1 according to the first embodiment, description of the same components and operation thereof will be omitted. The optical modulator 1 according to the third embodiment is different from the optical modulator 1 according to the first embodiment in that the optical modulator 1 according to the third embodiment has a first material layer 36 arranged between: an EO layer 33; and an upper cladding layer 34A and electrodes 22.

In terms of modulation efficiency, a structure having the electrodes 22 in direct contact with the EO layer 33 like the optical modulator 1 according to the first embodiment is desirable, but in terms of manufacturing errors, for example, a layer deposited on the EO layer 33 may be left beneath the electrodes 22 without being able to be fully removed. To address such a situation, arranging the first material layer 36 between the electrodes 22 and the EO layer 33 on purpose enables a stable layer structure to be obtained.

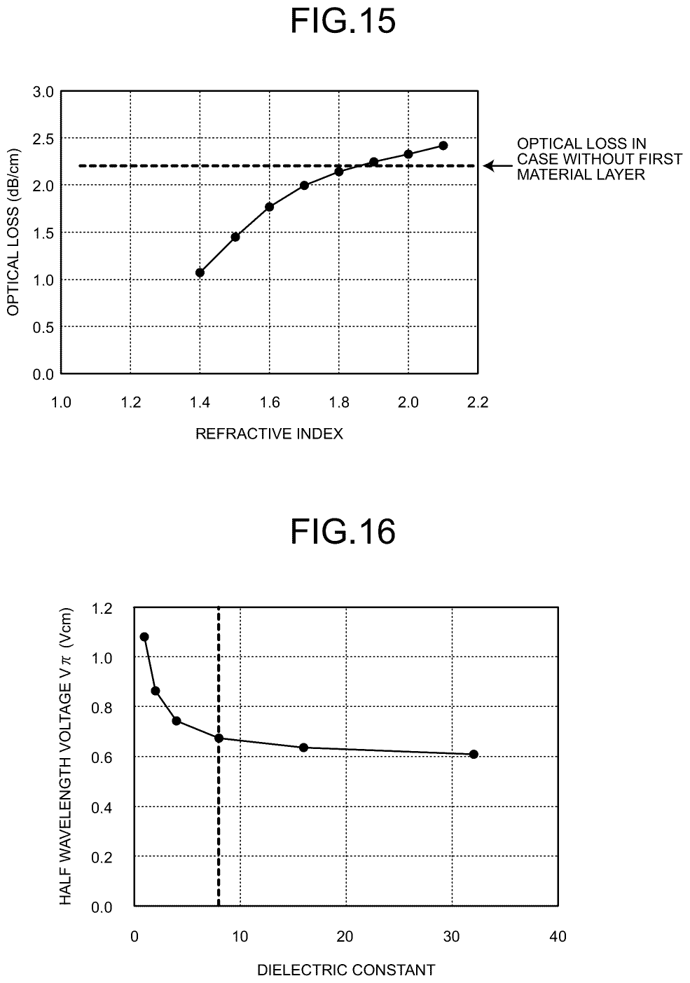

FIG. 15 is a diagram illustrating an example of a relation between the refractive index and the optical loss for the first material layer 36 in the optical modulator 1. Adopting a material having a refractive index lower than that of the EO layer 33 for the first material layer 36 prevents the extension of the optical distribution from the EO layer 33 to the electrodes 22, and the optical loss due to the optical absorption into the electrodes 22 is thus able to be reduced. This effect of reducing the optical loss is dependent on the refractive index of the first material layer 36, and as illustrated in FIG. 15, the optical loss is able to be reduced in a case where the first material layer 36 has a refractive index of 1.8 or lower, with the EO layer 33 having a refractive index of about 2.2. Therefore, in terms of reducing the optical loss, a material having a refractive index of 1.8 or lower, such as SiO₂, MgF₂, Al₂O₃ or MgO, is preferably adopted as the material for the first material layer 36.

FIG. 16 is a diagram illustrating an example of a relation between the dielectric constant and the half wavelength voltage Vπ of the first material layer 36 in the optical modulator 1. A high frequency electric signal may be applied also to the first material layer 36 arranged between the electrodes 22 and the EO layer 33 in the optical modulator 1 according to the third embodiment. In particular, in a case where a material having a low dielectric constant is arranged as the first material layer 36 between the electrodes 22 and the EO layer 33, the voltage applied to the first material layer 36 relatively becomes high and the electric field applied to the EO layer 33 is thus weakened. As a result, the half wavelength voltage Vπ is increased, as illustrated in FIG. 16. A material having a comparatively high dielectric constant of 8 or higher is thus preferably used for the first material layer 36 to minimize the increase in the half wavelength voltage Vπ and, for example, a material, such as MgO, HfO₂, Ta₂O₅, ZrO₂, or Nb₂O₅ is preferably used.

That is, the first material layer 36 in the optical modulator 1 according to the third embodiment is formed of at least any one of a material having a refractive index of 1.8 or lower and a material having a relative dielectric constant of 8 or higher.

The first material layer 36 is arranged between the electrodes 22 and the EO layer 33 in the optical modulator 1 according to the third embodiment and has a refractive index of 1.8 or lower. As a result, the first material layer 36 enables reduction of the extension of the optical distribution from the EO layer 33 to the electrodes 22 and reduction of the optical loss.

The first material layer 36 is arranged between the electrodes 22 and the EO layer 33 in the optical modulator 1 and has a relative dielectric constant of at least 8 or higher. As a result, the electric field applied to the EO layer 33 is strengthened and the increase in the half wavelength voltage Vπ is thus able to be minimized.

### (d) Fourth Embodiment

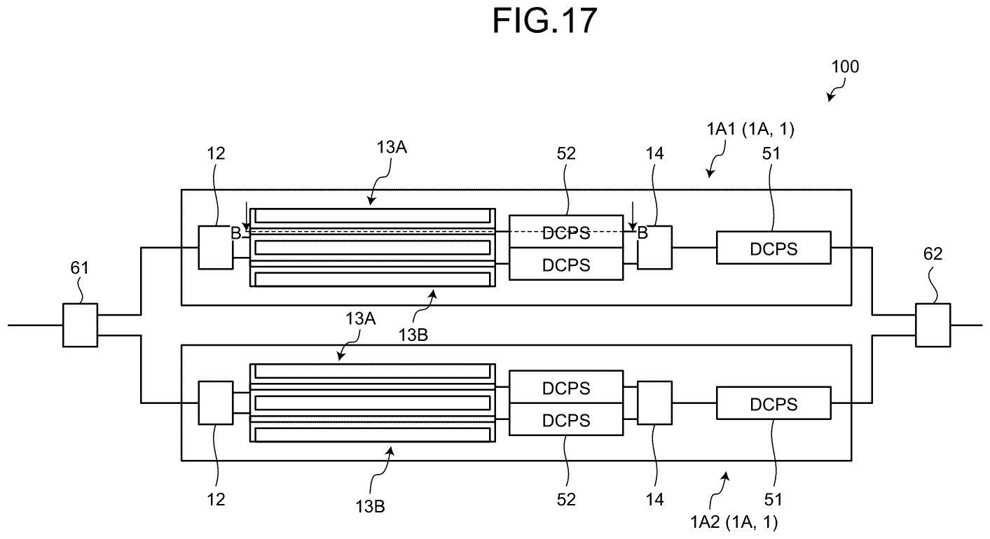

FIG. 17 is a schematic plan view of an example of a configuration of an IQ optical modulator 100 according to a fourth embodiment. By assignment of the same reference signs to components that are the same as those of the optical modulator 1 according to the first embodiment, description of the same components and operation thereof will be omitted. The IQ optical modulator 100 illustrated in FIG. 17 has a first splitter 61, an optical modulator 1A1 for an inphase (I) component, an optical modulator 1A2 for a quadrature (Q) component, two first direct current phase shifters (DCPSs) 51, and a first multiplexer 62. One of the first DCPSs 51 is a phase adjustment element to adjust the phase of signal light of the I component from the optical modulator 1A1 for the I component. The other one of the first DCPSs 51 is a phase adjustment element to adjust the phase of signal light of the Q component from the optical modulator 1A2 for the Q component.

The optical modulator 1A1 for the I component performs phase modulation of an optical signal of the I component. The optical modulator 1A2 for the Q component performs phase modulation of an optical signal of the Q component. The optical modulator 1A1 for the I component has a splitter 12, two modulation units 13A and 13B (13), two second DCPSs 52, and a multiplexer 14. The second DCPSs 52 are each a phase adjustment element to adjust the phase of signal light of the I component from the modulation unit 13. The optical modulator 1A2 for the Q component has a splitter 12, two modulation units 13A and 13B (13), two second DCPSs 52, and a multiplexer 14. The second DCPSs 52 are each a phase adjustment element to adjust the phase of signal light of the Q component from the modulation unit 13.

The first splitter 61 optically splits signal light from an input waveguide and outputs the signal light that has been optically split, to the optical modulators 1A1 and 1A2 (1) respectively. The optical modulator 1A1 for the I component outputs signal light of the I component from the multiplexer 14 in the optical modulator 1A1 to the first DCPS 51, the signal light having been subjected to phase modulation. The first DCPS 51 shifts the phase of the phase-modulated signal light of the I component and outputs the phase-shifted signal light of the I component to the first multiplexer 62.

The optical modulator 1A2 for the Q component outputs signal light of the Q component from the multiplexer 14 in the optical modulator 1A2 to the first DCPS 51, the signal light having been subjected to phase modulation. The first DCPS 51 shifts the phase of the phase-modulated signal light of the Q component and outputs the phase-shifted signal light of the Q component to the first multiplexer 62. The first multiplexer 62 multiplexes the signal light of the I component and the signal light of the Q component together and outputs the multiplexed signal light of the I and Q components to an output waveguide.

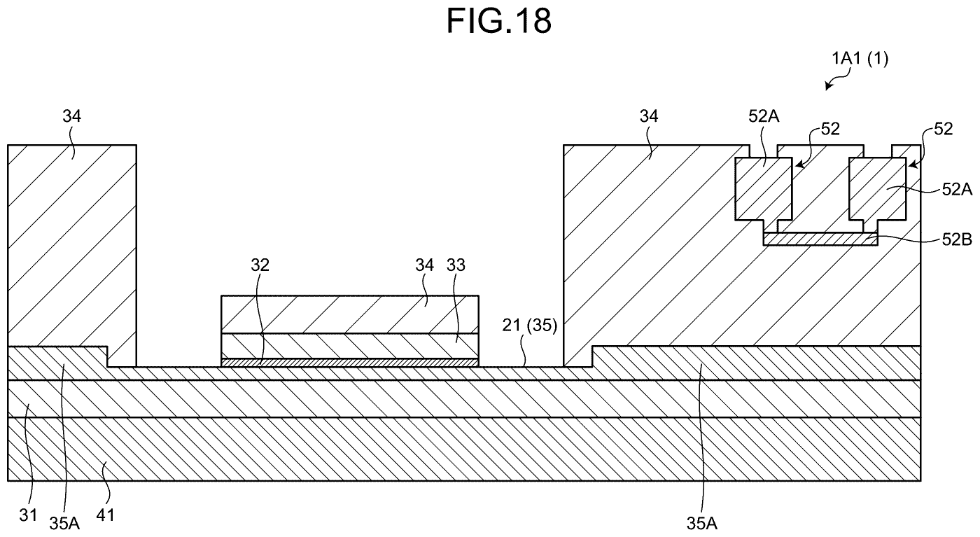

FIG. 18 is a schematic sectional view taken on a line B-B illustrated in FIG. 17. A portion at a cross section illustrated in FIG. 18 is a portion at a cross section of the optical modulator 1A1 for the I component. As illustrated in FIG. 18, a portion of the modulation unit 13 at the cross section of the optical modulator 1A1 for the I component has a Si substrate 41, a lower cladding layer 31, a thin Si core 35, a material layer 32, an EO layer 33, and an upper cladding layer 34.

A portion of the second DCPS 52 at the cross section of the optical modulator 1A1 for the I component has the Si substrate 41, the lower cladding layer 31, the thin Si core 35, the upper cladding layer 34, a thermo-optical heater 52B, and a metal wire 52A. The thermo-optical heater 52B is an electric resistance, such as TiN, arranged at a position near the thin Si core 35 that is the first modulation waveguide 21A. The metal wire 52A is a wire that is electrically connected to the thermo-optical heater 52B and supplies electric current to the thermo-optical heater 52B. Heat is generated in the thermo-optical heater 52B by flow of electric current from the metal wire 52A to the thermo-optical heater 52B. In the second DCPS 52, the phase of light passing through the first modulation waveguide 21A is shifted by change in the refractive index of silicon in the first modulation waveguide 21A, the change resulting from the heat in the thermo-optical heater 52B.

A ferroelectric EO material is used only for the portion of the modulation unit 13, the portion being at the cross section, the splitter 12 and the multiplexer 14 are formed using silicon photonics technology, and the splitter and multiplexer, as well as the DCPSs are thus able to be arranged in a small area. An optical modulator element that is able to be implemented as a result is small-sized, is capable of highly efficient and high-speed operation, and is highly integrated and highly functional.

A case where the splitter 12 and the multiplexer 14 included in the optical modulator 1 are also formed using a hybrid waveguide including a ferroelectric EO material and the thin Si core 35 has been described as an example. However, in a case where the optical modulator 1 is mounted on a silicon photonics element, forming the splitter 12 and the multiplexer 14 included in the optical modulator 1 using a silicon photonics waveguide enables downsizing by utilization of features of silicon photonics. Furthermore, forming, at the silicon photonics element, part of the two waveguides included in the optical modulator 1 enables implementation of a phase shifter for appropriately adjusting the phase in the optical modulator 1 by means of a heater formed on a waveguide and thus implementation of a small-sized and low power consumption DCPS. A DCPS using a heater can be used, not only for phase adjustment in the optical modulator 1, but also for phase adjustment between the I channel and Q channel in the IQ optical modulator 100.

The thin Si core 35 in the optical modulator 1A1 (1A2) has a core thickness of, for example, 0.07 μm, and a Si waveguide 35A connecting the splitter 12 and the multiplexer 14 to each other has a core thickness of, for example, 0.22 μm and a core width of, for example, 0.5 μm. Therefore, conversion waveguides for connection achieving low connection losses are arranged at an optical joint portion between the Si waveguide 35A connected to the splitter 12 and the thin Si core 35 and an optical joint portion between the Si waveguide 35A connected to the multiplexer 14 and the thin Si core 35, because of core thickness differences therebetween.

The IQ optical modulator 100 according to the fourth embodiment has the optical modulator 1A1 (1) for the I component and the optical modulator 1A2 (1) for the Q component, built therein. The optical modulator 1 has the EO layer 33 including an electro-optic material and the material layer 32 arranged below the EO layer 33 and having a dielectric constant lower than that of the EO layer 33. Furthermore, the optical modulator 1 has, for example: the thin Si core 35 arranged below the material layer 32 and having a refractive index higher than the refractive indices of the EO layer 33 and the material layer 32, for example, a refractive index of 3.45; and electrodes 22 for application of an electric signal to the EO layer 33. The refractive index of the material layer 32 is 0.85 times the refractive index of the EO layer 33 or higher. That is, making the refractive index of an electric signal comparatively low and increasing the group refractive index for light by means of the thin Si core 35 make the refractive index for an electric signal and the group refractive index for light closer to each other. As a result, the propagation velocity of an electric signal and the propagation velocity of light in the optical modulator 1 become substantially the same, and the velocity mismatch in the IQ optical modulator 100 is thus able to be improved. Therefore, the operating band of the IQ optical modulator 100 is able to be prevented from being limited. What is more, with the operating length maintained long, the velocity mismatch is improved in the IQ optical modulator 100, the half wavelength voltage Vπ is thus able to be reduced, and the modulation efficiency of the IQ optical modulator 100 is thus able to be improved.

A case where the IQ optical modulator 100 according to the fourth embodiment has the optical modulator 1 according to the first embodiment built therein has been described as an example, but the example may be modified as appropriate and the optical modulator 1 according to the second or third embodiment may be used instead.

### (e) Fifth Embodiment

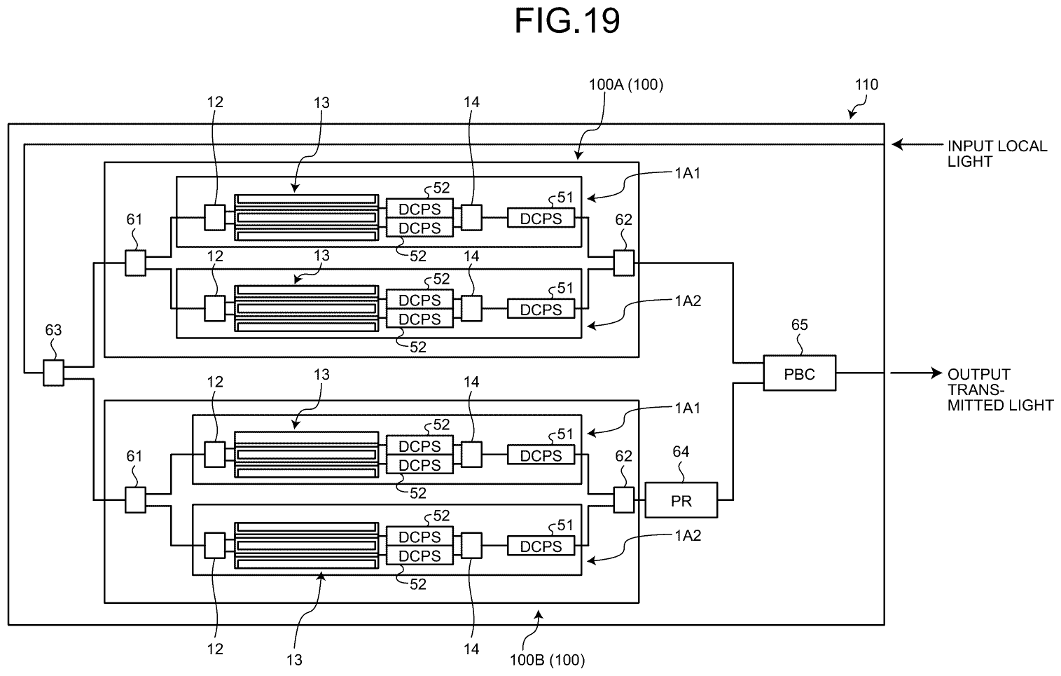

FIG. 19 is a schematic plan view of an example of a configuration of a DP-IQ optical modulator 110 according to a fifth embodiment. By assignment of the same reference signs to components that are the same as those of the IQ optical modulator 100 illustrated in FIG. 17, description of the same components and operation thereof will be omitted. The DP-IQ optical modulator 110 illustrated in FIG. 19 is formed by arrangement of four optical modulators 1 in parallel with each other. The DP-IQ optical modulator 110 has a second splitter 63, an IQ optical modulator 100A (100) for an X polarization component, an IQ optical modulator 100B (100) for a Y polarization component, a polarization rotator (PR) 64, and a polarization beam combiner (PBC) 65.

The second splitter 63 optically splits input light from an input waveguide and outputs signal light that has been optically split, to the IQ optical modulators 100 respectively. The IQ optical modulator 100A (100) for the X polarization component has an optical modulator 1A1 for an I component of the X polarization component and an optical modulator 1A2 for a Q component of the X polarization component.

The IQ optical modulators 100 each have a first splitter 61, an optical modulator 1A1 for the I component, an optical modulator 1A2 for the Q component, two first DCPSs 51 and a first multiplexer 62.

The first splitter 61 optically splits the signal light from the second splitter 63 and outputs the signal light that has been optically split, to optical modulators 1A1 and 1A2 respectively. The optical modulator 1A1 for the I component outputs signal light of the I component from a multiplexer 14 in the optical modulator 1A1 to the first DCPS 51, the signal light having been subjected to phase modulation. The first DCPS 51 shifts the phase of the phase-modulated signal light of the I component and outputs the phase-shifted signal light of the I component to the first multiplexer 62.

The optical modulator 1A2 for the Q component outputs signal light of the Q component from the multiplexer 14 in the optical modulator 1A2 to the first DCPS 51, the signal light having been subjected to phase modulation. The first DCPS 51 shifts the phase of the phase-modulated signal light of the Q component and outputs the phase-shifted signal light of the Q component to the first multiplexer 62. The first multiplexer 62 multiplexes the signal light of the I component and the signal light of the Q component together and outputs the multiplexed signal light of the I and Q components to the PBC 65.

The first multiplexer 62 in the IQ optical modulator 100A for the X polarization component multiplexes the signal light of the I component of the X polarization component from the multiplexer 14 in the optical modulator 1A1 for the I component and the signal light of the Q component of the X polarization component from the multiplexer 14 in the optical modulator 1A2 for the Q component together. The first multiplexer 62 outputs the signal light of the I and Q components of the X polarization component to the PBC 65.

The first multiplexer 62 in the IQ optical modulator 100B for Y polarization multiplexes the signal light of the I component of the Y polarization component from the multiplexer 14 in the optical modulator 1A1 for the I component and the signal light of the Q component of the Y polarization component from the multiplexer 14 in the optical modulator 1A2 for the Q component together. The first multiplexer 62 outputs the signal light of the I and Q components of the Y polarization component to the PR 64. The PR 64 subjects the signal light of the I and Q components of the Y polarization component to polarization rotation and outputs the signal light of the I and Q components of the Y polarization component that has been subjected to the polarization rotation to the PBC 65. The PBC 65 multiplexes the signal light of the I and Q components of the X polarization component and the signal light of the I and Q components of the Y polarization component that has been subjected to the polarization rotation together and outputs the multiplexed signal light of the X and Y polarization components as transmitted light to an output waveguide.

Because a ferroelectric EO material is used only for a portion of a modulation unit 13 at a cross section, the second splitter 63 for input to and output from the optical modulators 1, the first splitters 61 and the first multiplexers 62 for the I and Q components, and the PR 64 and PBC 65 for polarization separation and combination are formed using silicon photonics technology. Arrangement in a small area is thereby enabled. An optical modulator element that is able to be implemented as a result is small-sized, is capable of highly efficient and high-speed operation, and is highly integrated and highly functional.

A case where a splitter 12 and a multiplexer 14 included in the optical modulator 1 are also formed using a hybrid waveguide including a ferroelectric EO material and a Si core 35 has been described as an example. However, in a case where the optical modulator 1 is mounted on a silicon photonics element, forming the splitter 12 and the multiplexer 14 included in the optical modulator 1 using a silicon photonics waveguide enables downsizing by utilization of features of silicon photonics. Forming, at the silicon photonics element, part of two waveguides included in the optical modulator 1 enables implementation of a DCPS by means of a heater formed on a waveguide, the DCPS being for appropriately adjusting the phase in the optical modulator 1, and thus implementation of a small-sized and low power consumption phase shifter. A DCPS using a heater can be used, not only for phase adjustment in the optical modulator 1, but also for phase adjustment between the I channel and Q channel in the IQ optical modulators 100.

The DP-IQ optical modulator 110 according to the fifth embodiment has, built therein, the IQ optical modulator 100A for X polarization and the IQ optical modulator 100B for Y polarization. The optical modulator 1 has an EO layer 33 including an electro-optic material and a material layer 32 arranged below the EO layer 33 and having a dielectric constant lower than that of the EO layer 33. Furthermore, the optical modulator 1 has, for example: a Si core 35 arranged below the material layer 32 and having a refractive index higher than the refractive indices of the EO layer 33 and the material layer 32, for example, a refractive index of 3.45; and electrodes 22 for application of an electric signal to the EO layer 33. The refractive index of the material layer 32 is 0.85 times the refractive index of the EO layer 33 or higher. That is, making the refractive index of an electric signal comparatively low and increasing the group refractive index for light by application of the Si core 35 make the refractive index for an electric signal and the group refractive index for light closer to each other. As a result, the propagation velocity of an electric signal and the propagation velocity of light in the optical modulator 1 become substantially the same, and the velocity mismatch in the DP-IQ optical modulator 110 is thus able to be improved. Therefore, the operating band of the DP-IQ optical modulator 110 is able to be prevented from being limited. What is more, with the operating length maintained long, the velocity mismatch is improved in the DP-IQ optical modulator 110, the half wavelength voltage Vπ is thus able to be reduced, and the modulation efficiency of the DP-IQ optical modulator 110 is thus able to be improved.

In a structure having the optical modulator 1 mounted on a silicon photonics element, the optical modulator 1 using a ferroelectric EO material, the optical modulator 1 and a thin Si waveguide 35A of silicon photonics may be optically coupled to each other by connection between the Si core 35 and the thin Si waveguide 35A. Appropriate width and thickness of the Si core 35 in the optical modulator 1 are different from a core width and a core thickness of the thin Si waveguide 35A used in general silicon photonics, and this connection may thus be modified as appropriate and a conversion waveguide for connection with a smaller loss may thus be inserted.

### (f) Sixth Embodiment

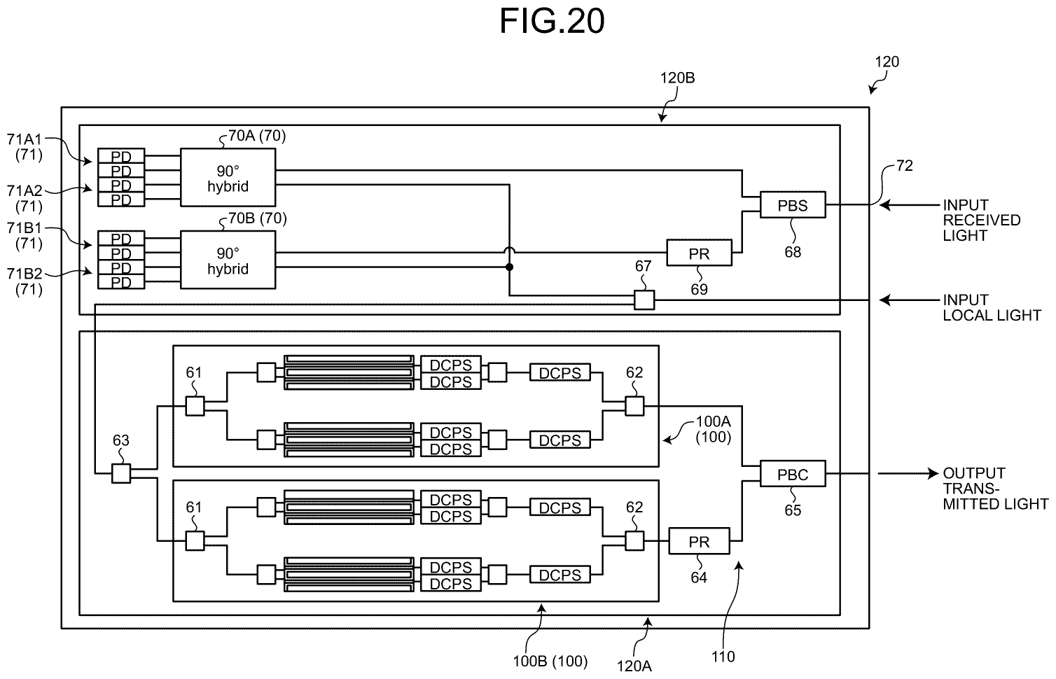

FIG. 20 is a schematic plan view of an example of a configuration of an optical transmitter-receiver 120 according to a sixth embodiment. By assignment of the same reference signs to components that are the same as those of the DP-IQ optical modulator 110 illustrated in FIG. 19, description of the same components and operation thereof will be omitted. The optical transmitter-receiver 120 illustrated in FIG. 20 has an optical modulator element 120A including a DP-IQ optical modulator 110 and an optical receiver element 120B to receive a DP-QAM signal. The optical transmitter-receiver 120 has the optical modulator element 120A and the optical receiver element 120B integrated onto the optical transmitter-receiver 120 by use of silicon photonics technology. The optical modulator element 120A is, for example, the DP-IQ optical modulator 110. The optical receiver element 120B has a third splitter 67, a received light input unit 72, a polarization beam splitter (PBS) 68, a polarization rotator (PR) 69, a first optical hybrid circuit 70A (70), and a second optical hybrid circuit 70B (70). The optical receiver element 120B has four first light receiving elements 71A (71) and four second light receiving elements 71B (71).

The third splitter 67 optically splits light coming through an input waveguide from a light source not illustrated in the drawings, outputs one of the optically split light to a second splitter 63 in the DP-IQ optical modulator 110, the one serving as an input light source of the modulator, and outputs the other one of the optically split light as local oscillator light of a receiver, to each of the hybrid circuits 70. The received light input unit 72 inputs received light from an optical fiber not illustrated in the drawings. The PBS 68 splits the input received light from the received light input unit 72 into X polarization received light and Y polarization received light, outputs the X polarization received light to the first optical hybrid circuit 70A and outputs the Y polarization received light to the PR 69. The PR 69 subjects the Y polarization received light to polarization rotation of 90 degrees and outputs the Y polarization received light that has been subjected to the polarization rotation, to the second optical hybrid circuit 70B.

The first optical hybrid circuit 70A obtains optical signals of an I component and a Q component by causing the local oscillator light to interfere with an X polarization component of the received light. The first optical hybrid circuit 70A outputs the optical signal of the I component to a first light receiving element 71A1, the optical signal being from the X polarization component. The first optical hybrid circuit 70A outputs the optical signal of the Q component to a first light receiving element 71A2, the optical signal being from the X polarization component.

The second optical hybrid circuit 70B obtains optical signals of the I component and the Q component by causing the local oscillator light to interfere with a Y polarization component of the received light. The second optical hybrid circuit 70B outputs the optical signal of the I component to a second light receiving element 71B1, the optical signal being from the Y polarization component. The second optical hybrid circuit 70B outputs the optical signal of the Q component to a second light receiving element 71B2, the optical signal being from the Y polarization component.

The first light receiving element 71A1 is, for example, a photodetector (PD) that performs electric conversion of the optical signal of the I component of the X polarization component from the first optical hybrid circuit 70A and outputs an electric signal of the I component resulting from the electric conversion. The first light receiving element 71A2 performs electric conversion of the optical signal of the Q component of the X polarization component from the first optical hybrid circuit 70A and outputs an electric signal of the Q component resulting from the electric conversion. The second light receiving element 71B1 is, for example, a PD that performs electric conversion of the optical signal of the I component of the Y polarization component from the second optical hybrid circuit 70B and outputs an electric signal of the I component resulting from the electric conversion. The second light receiving element 71B2 performs electric conversion of the optical signal of the Q component of the Y polarization component from the second optical hybrid circuit 70B and outputs an electric signal of the Q component resulting from the electric conversion.

The optical transmitter-receiver 120 according to the sixth embodiment has the optical modulator element 120A including the DP-IQ optical modulator 110, and the optical receiver element 120B, mounted thereon by silicon photonics technology and is thus able to be downsized.

The optical modulator element 120A has the DP-IQ optical modulator 110 having plural optical modulators 1 built therein. The optical modulators 1 each have an EO layer 33 including an EO material and a material layer 32 arranged below the EO layer 33 and having a dielectric constant lower than that of the EO layer 33. Furthermore, the optical modulators 1 each have, for example: a Si core 35 arranged below the material layer 32 and having a refractive index higher than the refractive indices of the EO layer 33 and the material layer 32, for example, a refractive index of 3.45; and electrodes 22 for application of an electric signal to the EO layer 33. The refractive index of the material layer 32 is 0.85 times the refractive index of the EO layer 33 or higher. That is, making the refractive index of an electric signal comparatively low and increasing the group refractive index for light by application of the Si core 35 make the refractive index for an electric signal and the group refractive index for light closer to each other. As a result, the propagation velocity of an electric signal and the propagation velocity of light in the optical modulator 1 become substantially the same, and the velocity mismatch in the DP-IQ optical modulator 110 is thus able to be improved. Therefore, the operating band of the DP-IQ optical modulator 110 is able to be prevented from being limited. What is more, with the operating length maintained long, the velocity mismatch is improved in the DP-IQ optical modulator 110, the half wavelength voltage Vπ is thus able to be reduced, and the modulation efficiency of the DP-IQ optical modulator 110 is thus able to be improved.

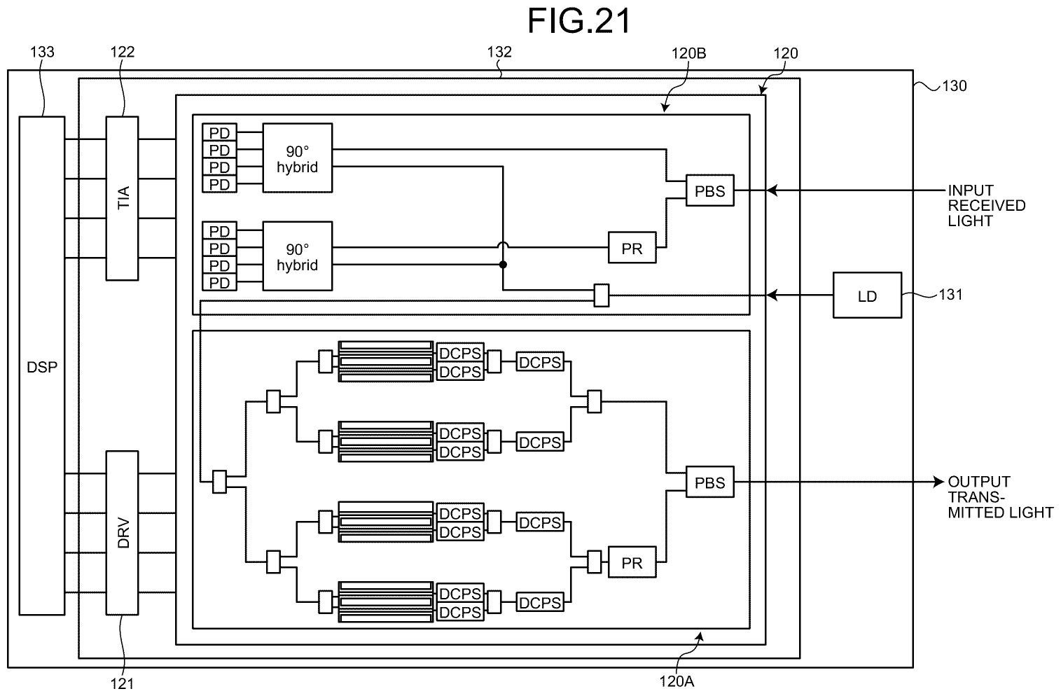

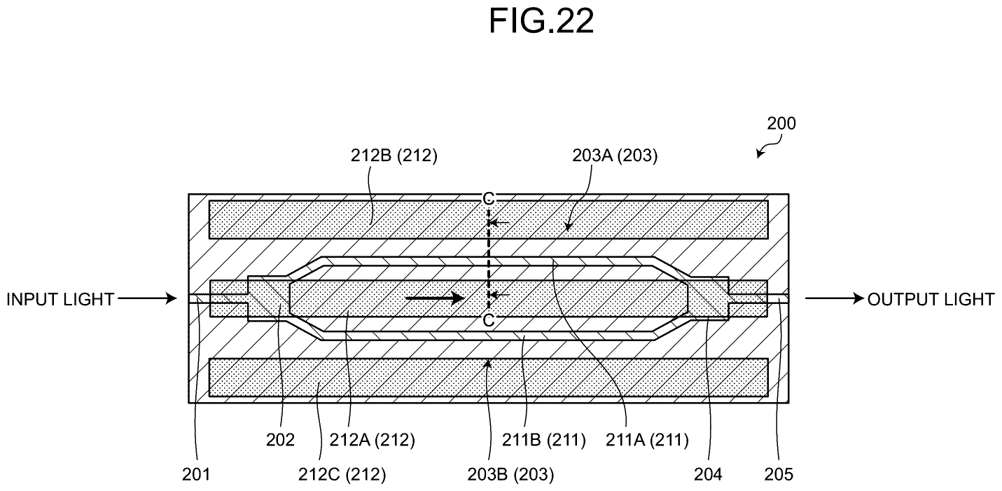

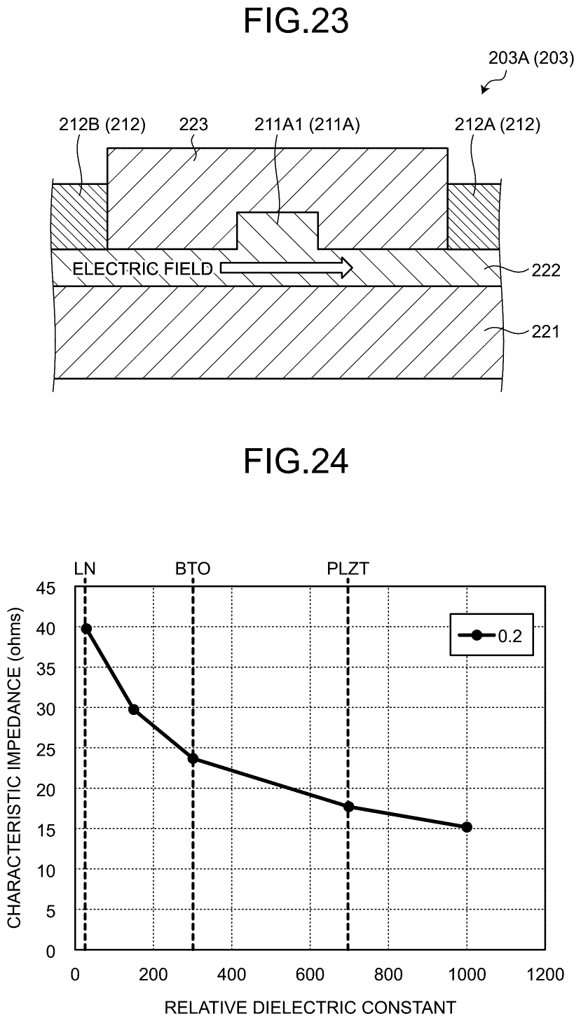

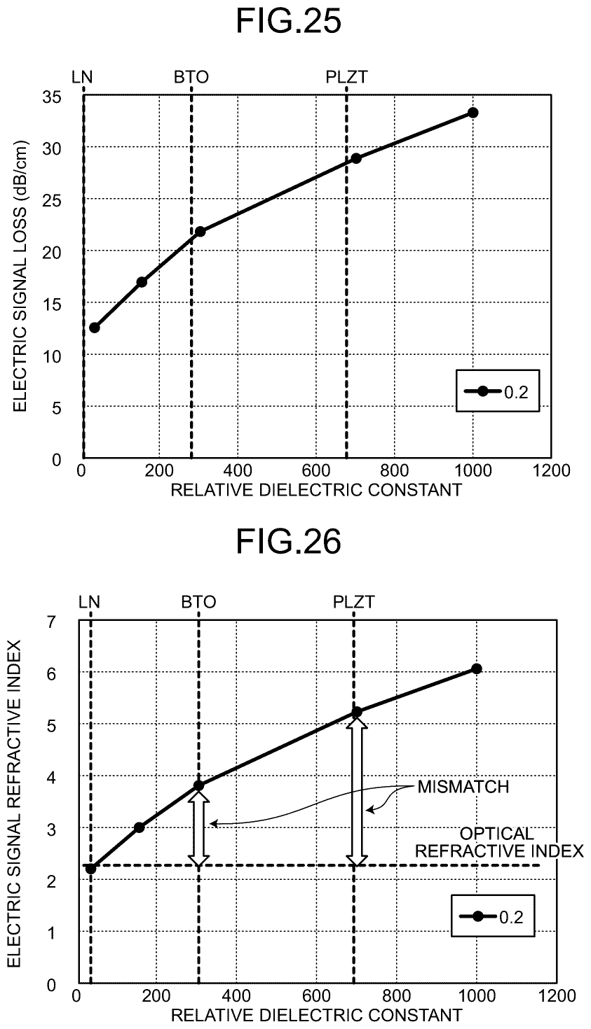

The following description is on an optical transceiver 130 having, adopted therein, the optical modulator 1 according to the embodiments. FIG. 21 is a diagram illustrating an example of the optical transceiver 130. The optical transceiver 130 illustrated in FIG. 21 has an LD 131, a transmitter-receiver module 132, and a digital signal processor (DSP) 133. The LD 131 is, for example, a light source that emits laser light. The transmitter-receiver module 132 has an optical transmitter-receiver 120, a driver circuit (DRV) 121, and a transimpedance amplifier (TIA) 122. The optical transmitter-receiver 120 has an optical modulator element 120A and an optical receiver element 120B. The optical modulator element 120A is, for example, a DP-IQ optical modulator 110A. The DSP 133 controls the whole optical transmitter-receiver 120. The DSP 133 is an electric component that executes digital signal processing, such as IQ modulation processing of a transmitted signal and demodulation processing of a received signal.

For example, the DSP 133 executes processing, such as coding of transmitted data, generates an electric signal including the transmitted data, and outputs the generated electric signal to the driver circuit 121. The driver circuit 121 drives the optical modulator element 120A according to the electric signal from the DSP 133.

The optical receiver element 120B performs electric conversion of signal light. The TIA 122 amplifies an electric signal resulting from the electric conversion and outputs the amplified electric signal to the DSP 133. The DSP 133 obtains received data by executing processing, such as decoding of the electric signal obtained from the TIA 122.

For convenience of description, a case where the optical transceiver 130 has, built therein, the optical modulator element 120A and the optical receiver element 120B has been described as an example, but this embodiment is also applicable to an optical transmission and reception device having only the optical modulator element 120A built therein.

Because the optical modulator 1 in the optical modulator element 120A is highly efficient, low power consumption operation of the optical transceiver 130 is enabled with the output amplitude of the driver circuit 121 being reduced, and because the optical transceiver 130 operates at high speed, large capacity optical signal transmission is enabled. As a result, a high capacity and low power consumption optical communication module is able to be implemented.

The components of each unit illustrated in the drawings may be not configured physically as illustrated in the drawings. That is, specific forms of separation and integration of each unit are not limited to those illustrated in the drawings, and all or part of each unit may be configured to be functionally or physically separated or integrated in any units according to various loads and use situations, for example.

Furthermore, all or any part of various processing functions implemented by each device may be executed on a central processing unit (CPU) (or a microcomputer, such as a micro processing unit (MPU) or a micro controller unit (MCU)). Furthermore, all or any part of the various processing functions may of course be executed on a program analyzed and executed by a CPU (or a microcomputer, such as an MPU or MCU) or on hardware by wired logic.

According to one embodiment of an optical modulator disclosed by the present application, for example, an optical modulator is provided, the optical modulator enabling improvement of its modulation efficiency while securing an operating band of the optical modulator.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical modulator comprising:
an electro-optic layer including an electro-optic material;
a material layer arranged below the electro-optic layer and having a dielectric constant lower than a dielectric constant of the electro-optic layer;
a core layer arranged below the material layer and having a refractive index higher than refractive indices of the electro-optic layer and the material layer; and
an electrode that applies an electric signal to the electro-optic layer, wherein
the refractive index of the material layer is 0.85 times the refractive index of the electro-optic layer or higher.

2. The optical modulator according to claim 1, wherein the electro-optic layer has an electro-optic coefficient higher than an electro-optic coefficient of the material layer.

3. The optical modulator according to claim 1, wherein
the electro-optic layer has a relative dielectric constant higher than 50 and the electro-optic layer has an electro-optic coefficient higher than 50 pm/V, and
the material layer has a relative dielectric constant equal to or less than 50 and the material layer has an electro-optic coefficient equal to or less than 50 pm/V.

4. The optical modulator according to claim 1, wherein the electro-optic layer includes BaTio₃ (BTO), PbLaZrTiO₃ (PLZT), or PbZrTiO₃ (PZT) or any combination thereof.

5. The optical modulator according to claim 1, wherein the material layer includes Ta₂O₅ or Si or a combination thereof.

6. The optical modulator according to claim 1, wherein the electro-optic layer has a thickness in a range of 0.1 μm to 0.3 μm, the core layer has a thickness in a range of 0.05 μm to 0.10 μm, and the material layer has a thickness of 0.005 μm to 0.05 μm or less.

7. The optical modulator according to claim 1, wherein a joint portion where an input waveguide connected to an input port of the optical modulator is connected to the core layer or a joint portion where an output waveguide connected to an output port of the optical modulator is connected to the core layer has a core thickness converter where thickness of the core layer is converted from a thickness of 0.05 μm to 0.10 μm, to a thickness of 0.15 μm or larger.

8. The optical modulator according to claim 1, further including:
a cladding layer arranged on at least part of the electro-optic layer, the part being on the core layer, wherein
the cladding layer has a relative dielectric constant of 15 or less and a refractive index of 1.8 or less.

9. The optical modulator according to claim 1, further including:
a cladding layer arranged on at least part of the electro-optic layer, the part being on the core layer, wherein
the cladding layer includes SiO₂, MgF₂, MgO, Al₂O₃ or a resin or any combination thereof, the resin having a refractive index of 1.8 or less.

10. The optical modulator according to claim 1, further including:
a first material layer arranged between the electrode and the electro-optic layer, wherein
the first material layer has a refractive index of 1.8 or less.

11. The optical modulator according to claim 10, wherein the first material layer includes SiO₂, MgF₂, Al₂O₃ or Mgo or any combination thereof.

12. The optical modulator according to claim 1, further including:
a first material layer arranged between the electrode and the electro-optic layer, wherein
the first material layer has a relative dielectric constant of at least 8 or higher.

13. The optical modulator according to claim 12, wherein the first material layer includes MgO, HfO₂, Ta₂O₅, ZrO₂ or Nb₂O₅ or any combination thereof.

14. The optical modulator according to claim 1, wherein the optical modulator has two optical waveguides serving as the core layer, an electrode that applies an electric signal to each of the two optical waveguides, a splitter that splits light to the two optical waveguides, and a multiplexer that multiplexes light from the two optical waveguides together, and the optical modulator modulates light guided through the two optical waveguides according to the electric signal.

15. An optical transmitter-receiver comprising:
an optical modulator element that modulates light guided according to an electric signal; and
an optical receiver element that converts received light that is received, to an electric signal, wherein
the optical modulator element includes:
an electro-optic layer including an electro-optic material;
a material layer arranged below the electro-optic layer and having a dielectric constant lower than a dielectric constant of the electro-optic layer;
a core layer arranged below the material layer and having a refractive index higher than refractive indices of the electro-optic layer and the material layer; and
an electrode that applies an electric signal to the electro-optic layer, and
the refractive index of the material layer is 0.85 times the refractive index of the electro-optic layer or higher.

16. The optical transmitter-receiver according to claim 15, further including:
a driver that drives the optical modulator element; and
an amplifier that amplifies the electric signal from the optical receiver element.

17. An optical transceiver comprising:
an optical modulator element that modulates light guided according to an electric signal;
an optical receiver element that converts received light that is received, to an electric signal; and
a signal processor that generates the electric signal to the optical modulator element and obtains the electric signal from the optical receiver element, wherein
the optical modulator element includes:
an electro-optic layer including an electro-optic material;
a material layer arranged below the electro-optic layer and having a dielectric constant lower than a dielectric constant of the electro-optic layer;
a core layer arranged below the material layer and having a refractive index higher than refractive indices of the electro-optic layer and the material layer; and
an electrode that applies an electric signal to the electro-optic layer, and
the refractive index of the material layer is 0.85 times the refractive index of the electro-optic layer or higher.
